(19) United States
(12) Patent Application Publication
(10) Pub. No.: US 2020/0130437 A1
(43) Pub. Date: Apr. 30, 2020

(54) Apparatus and method for automatic tire inflation system

(71) Applicants: Jeffrey T. Root, Howell, MI (US); Carl H. Schell, Waterford, MI (US); Lynn DaDeppo, Bloomfield Hills, MI (US); Marcello Tedesco, Fort Gratiot, MI (US); Ehab Kamal, Oro Valley, AZ (US)

(72) Inventors: Jeffrey T. Root, Howell, MI (US); Carl H. Schell, Waterford, MI (US); Lynn DaDeppo, Bloomfield Hills, MI (US); Marcello Tedesco, Fort Gratiot, MI (US); Ehab Kamal, Oro Valley, AZ (US)

(73) Assignee: APPLIED MECHATRONIC PRODUCTS, LLC

(21) Appl. No.: 16/350,283

(22) Filed: Oct. 25, 2018

(51) Int. Cl. B60C 23/12; H02K 7/18; H02K 7/116

(52) U.S. Cl. CPC B60C 23/12; B60C 23/008; H02K 7/116; H02K 7/1846

(57) ABSTRACT

A vehicle control system may include a wheel end unit attachable to the wheel-end of a wheeled vehicle. The system may employ one or more sensors to adjust wheel-end parameters and analyze sensor readings to diagnose conditions related to vehicle components, including tires, axles, bearings or components of the monitoring system. The system may analyze readings to predict conditions related to vehicle components or to components of the monitoring system. Wheel-end systems may be modular, allowing different implementations to include varying degrees of mechanical or electrical monitoring, analysis and control.

### RELATED APPLICATIONS

This application claims benefit of U.S. Provisional application entitled, VEHICLE MONITORING, ANALYSIS AND ADJUSTMENT SYSTEM,” Application No. 62/707,265, filed Oct. 26, 2017, which is hereby incorporated by reference in its entirety. This application is being filed on the same date as Applications having the same inventorship as this application and having the titles “APPARATUS AND METHOD FOR VEHICULAR MONITORING, ANALYSIS, AND CONTROL,” “APPARATUS AND METHOD FOR VEHICLE WHEEL-END GENERATOR,” “APPARATUS AND METHOD FOR VEHICLE WHEEL-END FLUID PUMPING,” and “APPARATUS AND METHOD FOR VEHICULAR MONITORING, ANALYSIS AND CONTROL OF WHEEL-END SYSTEMS,” the contents of which are hereby incorporated by reference in their entirety.

### BACKGROUND

Inventive concepts relate generally to a system and method for monitoring and adjusting vehicle characteristics. In particular, inventive concepts relate to a system and method for monitoring, inflating, maintaining tire and wheel related parameters, including air pressure and other parameters, analyzing related data and employing the related data for vehicle operation and maintenance.

Underinflated tires can adversely affect vehicle performance through reduced handling characteristics, lower fuel economy, increased tire wear, road side break downs, etc. However, insuring proper tire inflation is time-consuming and can be a dirty and difficult task. Tire Pressure Monitoring Systems (monitor, analysis, and control system) have been proposed as a means of monitoring tire pressure and advising an operator of the state of pressurization in a tire when the pressure is below a target pressure level. Typically, such monitoring systems merely provide an indication of tire pressure inflation level; they do not resolve a tire inflation issue. To address an improper inflation issue, the vehicle must be stationary and proper inflation equipment (both inflation and measuring equipment) must be available, and they often are not.

Although automatic tire inflation systems (ATIS) are available, these systems are costly and difficult to install, particularly for vehicles such as large trucks. Such systems may require specially-ordered attaching equipment, such as custom drive axles. They also, typically, require an extended amount of installation time, making retrofitting an arduous and costly task. These systems do not provide tire status information; they generally maintain targeted tire pressures by pumping air from a reservoir into a tire as the tire's air pressure falls below targeted levels.

### SUMMARY OF THE INVENTION

In example embodiments in accordance with principles of inventive concepts a wheel-end unit may be easily attached to an axle hub and provide active monitoring of tire pressure or other vehicle operating characteristics. The wheel-end unit may correct or report deflation or other vehicle anomalies. By employing a reliable, self-contained, energy source, the wheel-end unit may collect, assess, analyze, and report system status at a high frequency. In example embodiments a wheel-end unit incorporates an electrical generator at the wheel hub to provide hub-mounted electrical devices a reliable source of power. In example embodiments a mechanical, electrical, or both mechanical and electrical, control system measures, analyzes, reports status and controls, for example, an onboard air compressor to provide a combination of performance, reliability, and long service intervals.

In example embodiments, a system may include a device that may be mounted on a rotating body, such as a wheel of a vehicle. The device may be mounted on driven or non-driven wheels and on vehicles that may range in use from commercial, to industrial, to personal, to recreational.

In example embodiments a wheel-end unit may include an inertial power generator or energy harvester that may include a quasi-stationary element (also referred to herein as a stationary element) in the form of a weighted pendulum, which may be supported by a shaft along a central axis of the system and is free to rotate thereabout. The power generator may include a mechanical coupler (also referred to herein as a transmission system, or, simply, a transmission) with which a control system selectively couples and uncouples the quasi-stationary element to an air compressor system, which, along with the transmission, rotates with the rotation of the vehicle's wheel. With the coupling and mechanical/air compressor system rotating and the pendulum substantially stationary, the pendulum applies a torque to the transmission, which transfers the torque to drive the air compressor system.

In example embodiments a wheel-end unit electrical system may employ an electrical generator that is coaxial with a system support, with the generator's stator coupled to the system support (thereby rotating with the rotational portion of the system) and the rotor is coupled to the pendulum, thereby remaining substantially stationary; the relative rotation between the stator and rotor generates electricity. Electricity thus-generated may be used by electronics directly (with normal conditioning) and/or supplied to an electrical storage system.

In example embodiments, the electrical system may include a variety of sensors that are monitored by a controller (such as a microcontroller, for example). The controller obtains data from various sensors and processes the data. The processed data may be stored, analyzed and transmitted. The results of analyses may be used by the controller to position on an actuator that engages an air compressor with the pendulum.

In example embodiments in accordance with principles of inventive concepts a system may include a control element wherein mechanical sensing provides tire dependent in series pressure monitoring.

In example embodiments in accordance with principles of inventive concepts a system may include control element wherein a mechanical valve can provide control action for one or more distinct prescribed target values.

In example embodiments in accordance with principles of inventive concepts a system may include a control element wherein a mechanical valve provides control action for a minimum target value below which no pumping action occurs.

In example embodiments in accordance with principles of inventive concepts a system may include a control element wherein a mechanical valve provides control action for a maximum target value above which no pumping action occurs.

In example embodiments in accordance with principles of inventive concepts a system may include a control element wherein a mechanical valve provides control action for a target range for which pumping systems are active.

In example embodiments in accordance with principles of inventive concepts a system may include an assembly wherein an equalizer member may cause the balancing of pressure between two tires and/or reservoirs if a pressure difference between two tires is at or less than a predetermined difference.

In example embodiments in accordance with principles of inventive concepts a system may include a control element whereby the activation or deactivation of a transmitting element that transmits power from a generator to a pumping system is determined by an electronic sensing element of the system.

In example embodiments in accordance with principles of inventive concepts a system may include a controller that may use raw sensor data input, calculated assessments, historic performance, or embedded processes, for example, to assess current system status.

In example embodiments in accordance with principles of inventive concepts a system may include a controller that may use raw sensor data input, calculated assessments, historic performance, or embedded processes, for example, to forecast future system status.

In example embodiments in accordance with principles of inventive concepts a system may include controller that may use raw sensor data, calculated assessments, historic performance, or embedded processes, for example, to determine control actions to be performed on the system.

In example embodiments in accordance with principles of inventive concepts a system may include controller that may use raw sensor data, calculated assessments, historic performance, or embedded processes, for example, to communicate system status and recommendations to a vehicle operator and/or vehicle responsible maintenance personnel.

In example embodiments in accordance with principles of inventive concepts a system may include a control system that includes electrically operated valves.

In example embodiments in accordance with principles of inventive concepts a system may include a valve control method wherein the operation of the valves in conjunction with a pump operation results in increasing the inflation state of a tire and/or tires to targeted levels.

In example embodiments in accordance with principles of inventive concepts a system may include a valve control method whereby the operation of valves results in equalization of pressure between two tires.

In example embodiments in accordance with principles of inventive concepts a system may include a valve control method whereby the operation of the valves results in decreasing the inflation state of a tire and/or tires to targeted levels.

In example embodiments in accordance with principles of inventive concepts a system may include a control system whereby the operation of electrical valves and control devices can be pulse width modulated controlled from the controller or direct current supplied directly from a power generator. The selection decision may be determined by a number of process states and product sensors related data analysis.

In example embodiments in accordance with principles of inventive concepts a system may include an assembly for automatically assessing inflation state and for inflating one or more tires, the assembly capable of rotating with the wheel and tire assembly.

In example embodiments in accordance with principles of inventive concepts a system may include an assembly including a unit that is fixedly attached to the wheel assembly to which are fitted the following systems: an energy harvesting system including a weighted element which remains substantially static and through the relative motion of the other elements of the system is capable of transmitting rotational energy; a transmitting element which is able of conveying and/or not conveying the rotational energy from the energy harvesting system as demanded; a control element able to discern appropriate energy transmission periods as well as monitor other elements of the device; an electronic control system capable of receiving data input and assessing system status; a pumping system capable of compressing incoming air and delivering same through a distribution apparatus to reservoir and/or tire systems; a cover assembly providing enclosure for the above systems and appropriate attaching construct to provide means of affixing the unit to a tire and wheel assembly.

In example embodiments in accordance with principles of inventive concepts a wheel-end unit may include a device that includes methods to assess the number of rotations of the system and the rotational speed of the system.

In example embodiments in accordance with principles of inventive concepts a wheel-end unit may include device wherein the method for assessing the rotations is a Hall sensor.

In example embodiments in accordance with principles of inventive concepts a wheel-end unit may include a device wherein the method for assessing the rotations is the monitoring of phase fluctuations of a signal developed by the rotation of the generator shaft.

In example embodiments in accordance with principles of inventive concepts a wheel-end unit may include a device wherein adjusting the temperature and/or moisture of a system, component, and/or area is done through use of resistive heating.

In example embodiments in accordance with principles of inventive concepts a wheel-end unit may include a device wherein the determination of the rate of pressure loss in a tire can be done based on tire pressure sensor data and pumping/reinflation rates measured both real time and over time.

In example embodiments in accordance with principles of inventive concepts a wheel-end unit may include a device wherein determining the period of time a tire can be maintained at target tire pressures for identified leak rates and defined reinflation capabilities can be assessed using wheel-end monitor, analysis and control performance data.

In example embodiments in accordance with principles of inventive concepts a wheel-end unit may include a device wherein monitor, analysis and control system forecasted tire inflation related information can be provided to the vehicle operator and/or the logistics manager relating to the time and/or distance that a tire and/or vehicle can be maintained at targeted inflation levels.

In example embodiments in accordance with principles of inventive concepts a wheel-end unit may include a method of operating an assembly for automatically monitoring and inflating a tire and/or plurality of tires, the method reflective of assembly (ies) capable of rotating with the wheel and tire assembly.

In example embodiments in accordance with principles of inventive concepts a wheel-end unit may include a method whereby temperature and pressure data collected from a tire and/or reservoir provides an assessment of the state of the tire pressure, properly inflated, underinflated, or overinflated.

In example embodiments in accordance with principles of inventive concepts a wheel-end unit may include a method that causes actuation of valving in a prescribed manner to result in the inflation of an underinflated tire to a targeted inflation level.

In example embodiments in accordance with principles of inventive concepts a wheel-end unit may include a method that causes actuation of valving in a prescribed manner to result in the deflation of an overinflated tire to a targeted inflation level.

In example embodiments in accordance with principles of inventive concepts a wheel-end unit may include a method that causes actuation of valving in a prescribed manner to result in the inflation pressure equalization between two tires.

In example embodiments in accordance with principles of inventive concepts a wheel-end unit may include a method wherein generated power is used to control system, component, and/or region temperature and/or moisture content through a selective resistive heating process.

In example embodiments in accordance with principles of inventive concepts a wheel-end unit may include a device wherein a method to utilize power generator signal phases and frequency may be used to determine axle rotations and vehicle speed.

In example embodiments in accordance with principles of inventive concepts a wheel-end unit may include a device wherein a method to monitor filtering performance indirectly by monitoring pumping efficiency, or other sensor or filter performance-related data may generate instructions to replace a filter assembly when needed (that is, when filter performance indicates a degree of degradation that fall within a proscribed range).

In example embodiments in accordance with principles of inventive concepts a wheel-end unit may include a device wherein a method for determining the rate of pressure loss in a tire can be determined based on tire pressure sensor data and pumping/reinflation rates measured both real-time and over time.

In example embodiments in accordance with principles of inventive concepts a wheel-end unit may include a device that determines the period of time a tire can be maintained at target tire pressures for identified leak rates and defined reinflation capabilities can be assessed.

In example embodiments in accordance with principles of inventive concepts a wheel-end unit may include a device wherein a method is determined to provide information to the vehicle operator and/or the logistics manager relating to the time and/or distance that a tire and/or vehicle can be maintained at targeted inflation levels.

In example embodiments in accordance with principles of inventive concepts a wheel-end unit may include a device that determines the operation of electrical valves and control devices by either pulse width modulated control from a controller or direct current supplied directly from a power generator. The selection between pulse width modulated control and direct current control determined according to process states and sensor data analysis by a controller to provide efficient control.

In example embodiments in accordance with principles of inventive concepts a wheel-end unit may include a device wherein a controller adjusts pumping action according to wheel-end temperatures, for example, to reduce pumping when temperatures reach a threshold level.

In example embodiments in accordance with principles of inventive concepts a wheel-end unit may employ thermal actuators.

In example embodiments in accordance with principles of inventive concepts a wheel-end unit may include a device to collect and analyze thermal sensor data, both on components internal and external to the wheel-end unit, and determine actions to be taken, including notifications, system operational, continued monitoring, etc. based upon those readings and analyses.

In example embodiments in accordance with principles of inventive concepts a wheel-end unit may include a device that sets wheel-end unit operational protocols as determined by preset protocols defined during the set-up of the system. Protocols and parameters that may be programmable may include, but not be limited to: alert notifications, type of item to alert, what person/entity to notify; system parameter settings: tire pressure setting, security setting (e.g. password, type of unauthorized removal actions, etc.), designated systems to activate/deactivate: system performance monitoring, diagnostic systems, prognostic systems, etc.

In example embodiments in accordance with principles of inventive concepts a wheel-end unit for monitoring a vehicle wheel-end includes a sensor to sense a physical characteristic of a vehicle to which the monitoring unit is attached; and a wheel-end energy harvester, the energy harvester including: a non-rotating element; a rotatable element coupled to a wheel; a transmission system including non-circular and non-centered gears; an engagement element to couple the non-rotating element to the rotatable element, wherein the non-rotating element generates a torque when engaged with the rotatable element and the rotatable element is rotating and the transmission system transmits the torque in the form of usable energy; the wheel-end unit also including a modular control system for controlling a parameter of the wheel-end unit, the modular control system including mechanical control.

In example embodiments in accordance with principles of inventive concepts a wheel-end unit for monitoring a vehicle wheel-end includes an energy harvester generating mechanical energy.

In example embodiments in accordance with principles of inventive concepts a wheel-end unit for monitoring a vehicle wheel-end includes mechanical energy employed to operate a fluid pumping system.

In example embodiments in accordance with principles of inventive concepts a wheel-end unit for monitoring a vehicle wheel-end includes an energy harvester generating electrical energy.

In example embodiments in accordance with principles of inventive concepts a wheel-end unit for monitoring a vehicle wheel-end includes mechanical control elements.

In example embodiments in accordance with principles of inventive concepts a wheel-end unit for monitoring a vehicle wheel-end includes electrical control elements.

In example embodiments in accordance with principles of inventive concepts a wheel-end unit for monitoring a vehicle wheel-end includes a controller to collect readings from a sensor and to employ sensor readings to analyze operation of the vehicle.

In example embodiments in accordance with principles of inventive concepts a wheel-end unit for monitoring a vehicle wheel-end includes a controller configured to employ trend analysis of sensor readings.

### BRIEF DESCRIPTION OF THE DRAWINGS

Example embodiments in accordance with principles of inventive concepts will be more clearly understood from the following detailed description taken in conjunction with the accompanying drawings in which:

FIG. 1 is a side view of a vehicle having a distributed tire inflation system in accordance with the principles of the present disclosure;

FIGS. 2a and 2b shows a schematic plan view of a motor vehicle and/or a trailered vehicle or an auxiliary vehicle configured with a distributed tire inflation system with distributed system controls and computation abilities in accordance with aspects of the invention.

FIGS. 3a and 3b show a view of a wheel and tire in which the wheel unit is fitted with a distributed smart inflator system as corresponds to the system in FIG. 1 and/or FIG. 2.

FIGS. 4a and 4b provides a perspective view of a monitor, analysis and control system with the upper cover removed showing a possible positional relationship of component systems.

FIG. 5a Shows an exploded view of the monitor, analysis and control system depicting the various systems with a mechanical based control system

FIG. 5b Shows an exploded view of the monitor, analysis and control system depicting the various systems with an electrical control system.

FIGS. 6a and 6b show cutaway views of a filter system in accordance with principles of inventive concepts;

FIG. 7 shows a battery system in accordance with principles of inventive concepts;

FIG. 8 Shows an Isometric Depiction of an example embodiment of an energy harvesting and power transmission system in accordance with principles of inventive concepts;

FIG. 9 Shows an exploded view of an example embodiment of an energy harvesting and power transmission system in accordance with principles of inventive concepts;

FIG. 10 Shows the pumping system in an assembled isometric view of an example embodiment in accordance with principles of inventive concepts;

FIG. 11 shows an exploded view of a pumping system in an example embodiment in accordance with principles of inventive concepts;

FIGS. 12a and 12b Shows a possible mechanical energy transfer in the pumping system that includes a non-circular gear set in an example embodiment in accordance with principles of inventive concepts;

FIG. 13a Shows a valving for a switching system for the Mechanically controlled embodiment of the monitor, analysis and control system in an example embodiment in accordance with principles of inventive concepts;

FIG. 13b shows, in section, an air transfer valve facilitating a thermal override in an example embodiment in accordance with principles of inventive concepts;

FIG. 14 Reflecting a sectional embodiment of an equalizer valve at an equalized state in an example embodiment in accordance with principles of inventive concepts;

FIG. 15 Reflecting a sectional embodiment of an equalizer valve at a non-equalized state in an example embodiment in accordance with principles of inventive concepts;

FIG. 16 Providing an exploded view of components within an equalizer valve in an example embodiment in accordance with principles of inventive concepts;

FIG. 17 Depicts a control diagram of an electrical embodiment of a monitor, analysis and control system in an example embodiment in accordance with principles of inventive concepts;

FIG. 18 Depicts an isometric diagram of an electrically controlled embodiment of the monitor, analysis and control system in an example embodiment in accordance with principles of inventive concepts;

FIG. 19 Suggests a valve, sensor, and reservoir configuration to achieve processes for performing inflation, deflation, and pressure equalization operations

FIG. 20 Represents a 2d sectional view of a typical mechanical regulating valve

FIG. 21 is a block diagram of an example embodiment of a vehicle monitoring and adjustment system in accordance with principles of inventive concepts;

FIG. 22 is a block diagram of a modular wheel-end control system employing mechanical energy harvesting in accordance with principles of inventive concepts;

FIG. 23 is a block diagram of a modular wheel-end control system employing mechanical and electrical energy harvesting in accordance with principles of inventive concepts;

and

FIGS. 24 and 25 are block diagrams illustrating modular options available to electrical and mechanical implementations.

### DETAILED DESCRIPTION

Example embodiments in accordance with principles of inventive concepts will now be described more fully with reference to the accompanying drawings, in which example embodiments are shown. Example embodiments in accordance with principles of inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. Like reference numerals in the drawings denote like elements, and thus their description may not be repeated. Example embodiments of systems and methods in accordance with principles of inventive concepts will be described in reference to the accompanying drawings and, although the phrase “example embodiments in accordance with principles of inventive concepts” may be used occasionally, for clarity and brevity of discussion example embodiments may also be referred to as “Applicants' system,” “the system,” “Applicants' method,” “the method,” or, simply, as a named component or element of a system or method, with the understanding that all are merely example embodiments of inventive concepts in accordance with principles of inventive concepts.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “or” includes any and all combinations of one or more of the associated listed items. Other words used to describe the relationship between elements should be interpreted in a like fashion (for example, “between” versus “directly between,” “adjacent” versus “directly adjacent,” “on” versus “directly on”). The word “or” is used in an inclusive sense, unless otherwise indicated.

It will be understood that, although the terms “first”, “second”, etc. may be used herein to describe various elements, components, regions, layers or sections, these elements, components, regions, layers or sections should not be limited by these terms. These terms are only used to distinguish one element, component, region, step, layer or section from another element, component, region, step, layer or section. Thus, a first element, component, region, step, layer or section discussed below could be termed a second element, component, region, step, layer or section without departing from the teachings of example embodiments.

Spatially relative terms, such as “beneath,” “below,” “lower,” “above,” “upper,” “top,” “bottom,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if an element in the figures is turned over, elements described as “bottom,” “below,” “lower,” or “beneath” other elements or features would then be oriented “atop,” or “above,” the other elements or features. Thus, the example terms “bottom,” or “below” can encompass both an orientation of above and below, top and bottom. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” or “including,” if used herein, specify the presence of stated features, integers, steps, operations, elements or components, but do not preclude the presence or addition of one or more other features, integers, steps, operations, elements, components or groups thereof. The word “or” is used in an inclusive sense to mean both “or” and “and/or.” The term “exclusive or” will be used to indicate that only one thing or another, not both, is being referred to.

Unless otherwise defined, all terms (including technical and scientific terms) used herein have the same meaning as commonly understood by one of ordinary skill in the art to which example embodiments in accordance with principles of inventive concepts belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

For clarity and brevity of description, inventive concepts may be described in terms of example embodiments related to large trucks. Although the following example embodiments focus on examples within the realm of large trucks, other wheeled vehicles, such as off-road vehicles, lift-trucks, industrial trucks, mining vehicles, automobiles, buses, in fact, any wheeled vehicle, are contemplated within the scope of inventive concepts.

The terms first, second, third, etc. may be used herein to describe various elements, components, regions, layers or sections. These elements, components, regions, layers or sections should not be limited by these terms. These terms may be only used to distinguish one element, component, region, step, layer or section from another region, step, layer or section. Terms such as “first,” “second,” and other numerical terms do not imply a sequence or order unless clearly indicated by the context. Thus, a first element, component, region, step, layer or section discussed below could be termed a second element, component, region, step, layer or section without departing from the teachings of the example configurations.

A vehicle monitoring, analysis, and control system in accordance with principles of inventive concepts may include a wheel-end unit positioned on a wheel-end of a vehicle to generate electrical power, to provide high-frequency sensing and monitoring of wheel-end parameters, to analyze wheel-end health and functionality, to provide real-time control of wheel functions, such as tire inflation and load balancing, to provide communications, for example, among wheel-end units, and to provide expandability of sensing capabilities.

In example embodiments a system in accordance with principles of inventive concepts may employ a component that rotates relative to the inertial reference frame of a rotating wheel to form what is referred to herein as an inertial power generator. The inertial power generator may generate electrical power for an electronic monitor analysis and control system in accordance with principles of inventive concepts and may provide power to a mechanical pumping system that provides air to one or more tires associated with a wheel-end. With a system in accordance with principles of inventive concepts attached to a wheel-end, as the vehicle moves a system housing and a portion of internal workings of the system rotate along with the axle and wheel-end with which it is associated. A portion of the system, referred to herein as an inertial electrical power generator, or a portion thereof, does not rotate along with the wheel-end. The differential rotation between the components that rotate along with the wheel-end and the components that do not is employed to generate electrical power. Power conditioning and electrical power storage, such as battery storage, may be employed to provide power to a system processor whether the vehicle associated with the wheel-end is moving or not. While the vehicle moves, power is generated by the inertial power generator; while the vehicle is stationary, power may be drawn from the electrical power storage.

A vehicle monitoring, analysis, and control system in accordance with principles of inventive concepts may provide continuous, high-frequency sampling of wheel-end parameters provided by sensors such as a tire pressure sensor, a tire temperature sensor, accelerometer sensor, audio sensor, or moisture sensor, for example. In example embodiments, the steady availability of power from the inertial electrical power generator enables continuous, high-frequency sampling of the various sensors, which, in turn, enables accurate monitoring, analysis and control of vehicle operations.

Applicants' system may perform latitudinal and longitudinal analyses of wheel-end functionality, providing diagnostics and prognostics for a wheel-end and for a vehicle associated therewith. Because Applicants' system generates its own electrical power, electrical power is always available while the vehicle is in motion. Because the system provides electrical energy storage, electrical energy is also available during periods of vehicle idleness. As previously noted, the constant availability of electrical power permits the system to continuously sense, at a high frequency, various vehicle parameters. The collected body of sensor readings allows the system to analyze wheel-end and vehicle performance in a manner far beyond the conventional detection of low tire-pressure. Applicants' system and method may perform extremely complex and accurate analyses in both the time and frequency domain. Frequency analyses may employ Fourier, Gabor, or Wavelet transforms, for example, with machine learning to analyze the state of a vehicle, to diagnose issues, to prognosticate, or predict, potential long-term problems or imminent failures, recommend maintenance or control operations that improve vehicle performance, such as controlling optimum tire inflation and load-balancing. The system's diagnostics may, for example, provide an indication of wheel-end “health” or overall performance of the vehicle, diagnose various issues, extend the lives of tires, of the wheel-end and of the system itself. All of this is directed to improving the overall safety, economy, and endurance of the wheeled vehicle.

Applicants' system may employ the system's detailed sensing, analyses, and diagnostics to provide real-time control of wheel-end functions, such as tire-pressure adjustment (raising or lowering the pressure) and load balancing.

Applicants' system may include a communications system that allows communications among wheel-end units, between wheel-end units and a vehicle central unit processor and between a wheel-end unit and an off-vehicle monitoring, maintenance and control systems. In this manner, a system may provide constant, real-time diagnostics and prognostics to a vehicle central processor, in a driverless vehicle embodiment, for example, or to remote monitoring and maintenance systems, for example.

A sensor complement may include tire pressure, tire temperature, audio sensors, accelerometer, Hall Effect sensor and moisture sensors, for example.

A wheel-end unit may communicate directly with other wheel-end units associated with the same vehicle, may communicate with other wheel-end units through an intervening hub, or may communicate with other wheel-end units through other communications channels, such as through the cloud. In example embodiments each wheel-end unit includes a controller that may detect accelerometer data to determine from vibration signatures whether the associated wheel is out-of-round by comparing the vibrational signature to the vibrational signature of wheels that are not out of round or by comparing the vibrational signature to the vibrational signature of wheels that are our of round. In example embodiments a wheel-end unit may compare measurements from axle to axle on the same vehicle to determine whether an associated axle is out of alignment (for example, if one wheel turns at a higher rate than another or) or brake dis-function (for example, brake drag or other failure) by comparing wheel rotation rates, temperature, and rate of change, for example. Tire failures, such as impending delamination or bulges, for example, may be determined by comparing wheel-end signatures (based upon sensor data, such as vibration, temperature, and pressure) with example wheel-end signatures that either exhibit such imminent failures (e.g., known bad) or do not exhibit such failures (known good). Such comparisons may also compare signatures from other wheel-end units associated with the same vehicle.

A vehicle monitoring and adjustment system in accordance with principles of inventive concepts may be attached to a vehicle's wheel-end to monitor and adjust, for example, the air pressure of a tire associated with the wheel-end to which the system is attached. A plurality of such systems may be employed on a vehicle, with individual systems attached to each vehicle wheel-end. In example embodiments a system in accordance with principles of inventive concepts may include an inertial power generator, a mechanical pumping system and either a mechanical or electrical control system and an optional communication system. Because the system is attached to a wheel-end, as the vehicle moves the housing and a portion of internal workings of the system rotate along with the axel and wheel-end with which it is associated. A portion of the system, referred to herein as an inertial power generator, or a portion thereof, does not rotate along with the wheel-end.

In example embodiments the inertial power generator includes a quasi-stationary element (also referred to herein as a stationary element) in the form of a weighted pendulum, which is supported by a shaft along a central axis of the system and is free to rotate thereabout. A mechanical coupler (also referred to herein as a transmission system, or, simply, a transmission) couples the quasi-stationary element to the pumping system, which, along with the transmission, rotates with the rotation of the vehicle's wheel. With the coupling and pumping system rotating and the pendulum substantially stationary, the pendulum applies a torque to the transmission, which transfers the torque to the pumping system. In example embodiments, the weighted pendulum is configured to supply sufficient torque to meet demands. That is, the pendulum is sized to, at one extreme, provide sufficient weight that the pendulum would always remain quasi-static (never move) under torque demands of the system, and at the other extreme, be just a bit more than a mass that would cause the pendulum to spin under a torque demand situation, making the system ineffective.

The minimum weight of the pendulum must be sufficiently large to drive the systems within the system accounting for multiple demands including: pumping, meeting other torque demands of the system (e.g. electrical power generation, start-up torques due to inertia, friction; starting vs. running, etc.), possible parasitic loss developments over the life of the system, as well as a performance margin (safety margin). As noted, the pendulum will have demands that are larger than the steady state running torques and these peak torques will drive the sizing of the pendulum mass. The running torques will fluctuate to some degree, as well. The design of the overall system has been structured to minimize the torque requirements. The system is structured to minimize the torque requirements by minimizing of drive torques, while not violating minimum pumping requirements. This may include gear drive ratios other than 1:1, possibly using a 2:1 average gear ratio, or similar type ratio between the drive gear and the driven gear. Additionally, to address the fluctuating torque demands, use of a unique torque transmission system using an elliptical gear system to provide added mechanical advantage at the point of highest compression of the compressor thus reducing fluctuation in the system peak torque demands. A lighter pendulum mass is beneficial in both the weight saving from the mass reduction of the pendulum itself, as well as, the benefits of lowered bearing and structural loading requirements associated with the lower pendulum mass. This translates into improved durability at a lower weight and allowing the collective weight saved to be applied in the transfer of added vehicle cargo.

In example embodiments, the optional electrical system may include a power source in the form of a primary or secondary battery. In example embodiments in which a secondary battery is used, the electrical system may employ an electrical generator that is coaxial with a system support, with the generator's stator coupled to the system support (thereby rotating with the rotational portion of the system) and the rotor is coupled to the pendulum, thereby remaining substantially stationary; the relative rotation between the stator and rotor generates electricity. Electricity thus-generated may be used by electronics directly (with normal conditioning) and/or supplied to an electrical storage system, such as a secondary battery. In embodiments in which a primary batter is used, the battery supplies power to the electronics directly and is replaced as needed.

The electrical system may include a variety of sensors that are monitored by a controller (such as a microcontroller, for example). The controller obtains data from various sensors and processes the data. The processed data may be stored, analyzed and transmitted. The results of analyses may be used by the controller to control the pumping system in order to inflate an associated vehicle tire, for example and/or may generate recommended actions, that may be either immediate in nature and/or of a maintenance ongoing nature associated with the state of the wheel end, axle system and/or trailer/tractor in total. This information may be transmitted to the driver and/or a third party in a variety of methods.

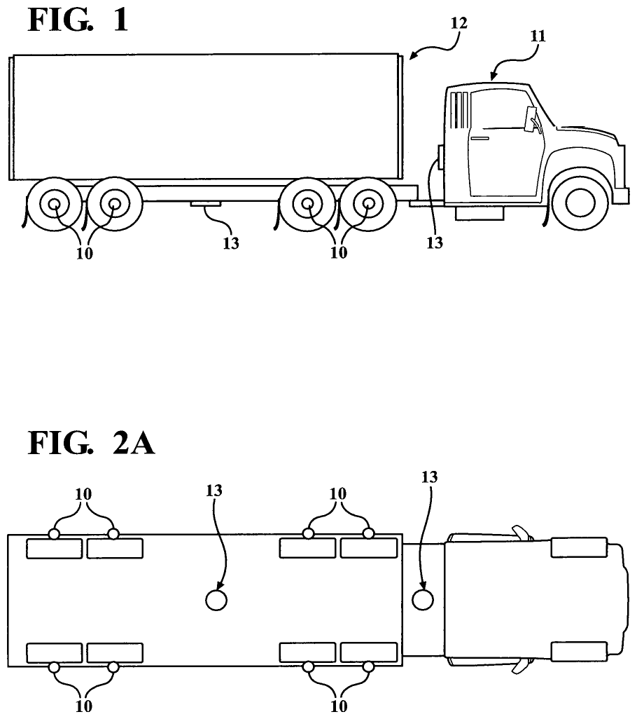

FIG. 1, illustrates, in side view, a plurality of vehicle monitoring systems 10 in accordance with principles of inventive concepts configured on a vehicle 11. In this example embodiment, the systems 10 are wheel-end monitor, analysis and control systems mounted on motored vehicles 11 and/or trailered units 12 (a tractor 11 and semi-trailer 12 in this example embodiment). The monitor, analysis and control systems 10 are shown installed on all powered and trailered (non-powered) wheel assemblies, though a combination of installed and not installed on some wheel assemblies is contemplated within the scope of inventive concepts (for example, installed on powered axles only, or installed on trailered (non-powered) axles only, or installed on a combination of both trailered (non-powered) and powered wheels or as depicted in the illustration). The systems 10 are installed on wheel-ends and embody a distributed set of tire pressure monitoring and automatic tire inflation systems 10. In accordance with principles of inventive concepts, each system 10 may operate autonomously to monitor and adjust vehicle attributes, such as tire pressure, associated with the wheel-end to which they are attached. Additionally, each system 10 may store, process, analyze and transmit or receive information (that is, raw data, analytical results or commands, for example) associated with the wheel-end to which they are attached. Such information may be shared with a central processor within a vehicle (located in either tractor 11 or trailer 12, for example) or one of the system 10 may operate as a central processor. Each wheel end system 10 may provide tire pressure monitoring and pressure adjustment for both single and multiple tire combinations as might be configured on a given wheel-end. Communication transmitting device 13 which may forward sensed, calculated, and/or analyzed information generated and/or obtained at the monitor, analysis and control system 10s to vehicle operators and/or logistics/maintenance providers as is instructed and/or designated by the communications controller 13.

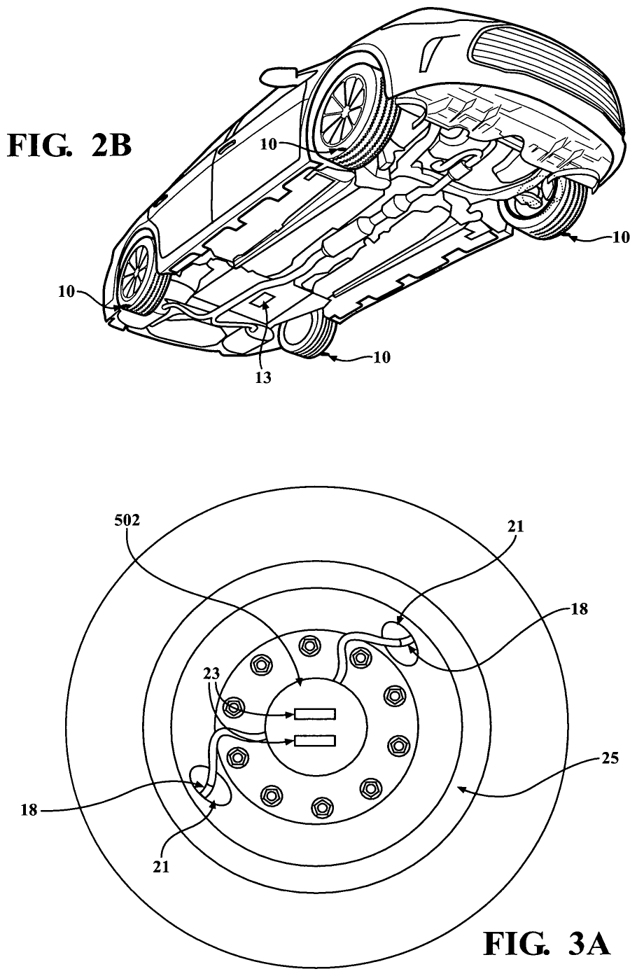

FIG. 2a is a plan view, schematic representation of FIG. 1 and displays monitor, analysis and control systems 10 on both motored 11 and trailered (non-powered) 12 vehicles. (FIG. 2b depicting a similar passenger vehicle representation). The communication module, transmitter/receiver unit (13) may be positioned on the motored vehicle 11 and/or on the trailered vehicle 12. The transmitter/receiver unit (13) may communicate between the individual and/or collective TMPIS systems 10 and the world external to the monitor, analysis and control system 10, as determined by preset protocols defined during the set-up of the system, for example. Programmable system parameters may include, but are not limited to: alert notifications, including the type of item to alert, what person/entity to notify; system parameter settings, including tire pressure setting, security setting (e.g. password, type of unauthorized removal actions, etc.); systems to activate, including system performance monitoring, diagnostic systems, prognostic systems, for example.

In example embodiments in accordance with principles of inventive concepts, the programming/set-up of the monitor, analysis and control systems 10 may be performed via a base unit and/or possibly via an application as installed on a smart phone.

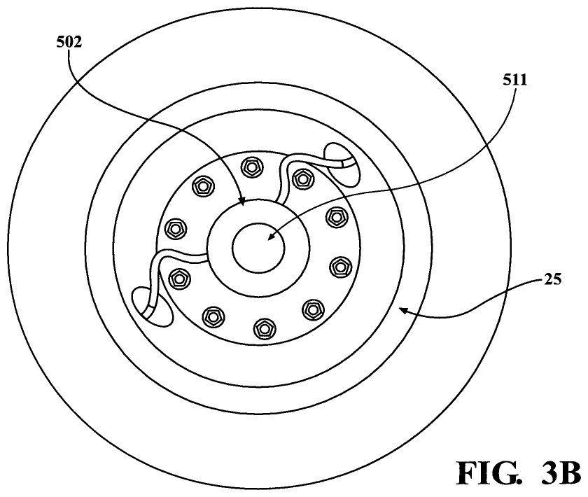

FIGS. 3a/b shows a close-up view of an example embodiment of a monitor, analysis and control system 10 in accordance with principles of inventive concepts fixed to a wheel 25. The monitor, analysis and control system 10 may provide connection to a reservoir and/or plurality of reservoirs 20 and/or connection to a tire 19 or plurality of tires, which may be made through separate fluid transmission devices. These fluid transmission devices may be tubes, hoses (“hose,” 18 as depicted in the FIG. 3a and as referred to hereinafter), and/or other types of fluid transfer devices connecting the monitor, analysis and control system 10 to the outer and inner tires 19a, 19b (illustrated on the rear tires of trailer 12 in FIG. 2, for example) by way of the air inlet port or valve 21 on each of the tires.

The monitor, analysis and control system end of the hose 18 may connect to ports 22 on the monitor, analysis and control system 10. The ports 22, in turn, may be connected to controls or sensors within the system 10 that may monitor and/or adjust the air pressure of the system 10 if the system controls detect parameter values outside of targeted value ranges. In example embodiments in accordance with principles of inventive concepts, the tire health monitoring and parameter-altering may be carried out while the vehicle is in motion and does not require the vehicle to be brought to a stop for either the monitoring or the parameter adjustment to occur.

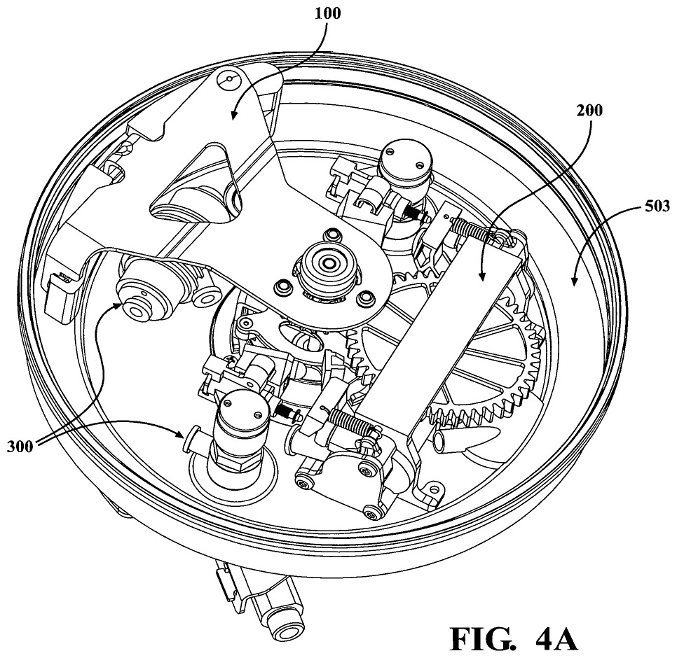

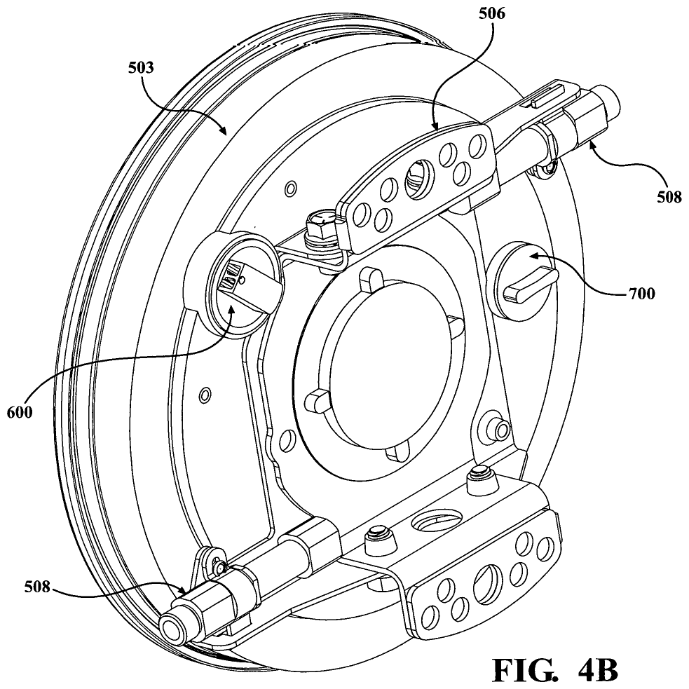

FIG. 5 is an exploded view of a system 10 in accordance with principles of inventive concepts that illustrates the internal components of an example embodiment of such a system, also illustrated in the front and rear isometric views of FIGS. 4a and 4b. The exploded view depicts several component systems of and/or within the system 10. A housing and mounting system 500 may include a top cover 502 and a bottom cover 503 that encompass the inner working of the monitor, analysis and control system elements. A retaining member 501 may hold the components in place. The retaining member 501 may provide a means of securing the two covers together in a compact manner and may also provide a means of insuring system tamper resistance, for example. The construction of the retaining member 501 may be such that once secured to the two outer covers 502 and 503, removal of the retaining member 501 may require severing (destruction) of the retaining member 501, thereby denying access to the system's 10 inner workings to anyone other than the manufacturer of the unit.

Collectively, the three members: bottom cover 503, top cover 502 and retaining member 501, may provide shielding for the monitor, analysis and control system internal components and systems from exposure to the external elements. The enclosure may contain a lubricant which may be of liquid and/or powder form, for example. In example embodiments, the rotation of the system 10, as well as the operational performance of the elements within the system 10, may provide for the distribution of the lubricating material within the assembly. Such lubricant may provide a low-friction surface on relative-motion contacting members, lowering operating friction and reducing associated surface wear and/or improving system durability.

The top cover 502, in addition to being part of the system 10 enclosure, may also have mounted onto its outer surface solar cells 511, as seen in FIG. 3b. The solar cells may be connected to the electrical system within the monitor, analysis and control system 10 10 and may provide supplemental power to the monitor, analysis and control system 10, particularly when the vehicle is stationary and/or when the system 10 may be demanding power supply in excess of the system's 10 main electrical power generation capability. The top cover 502 may also have mounted into its surface one or more clear areas 23, as depicted in FIG. 3a, which may be used to display the state of inflation of each associated tire.

The bottom cover 503 may provide the means of attaching or retaining the overall system 10 to a wheel hub via attachment to the intermediate attaching bracket 504, using bolts 505 and fastening nuts 506 or other fastening means. The intermediate attaching bracket 504 may attach to the wheel mounting bracket 506 using, for example, bolts 507. The wheel mounting bracket 506 may provide attachment of the monitor, analysis and control system Assembly (that is, system 10) to a wheel using the wheel's attaching studs and nuts (not shown).

In example embodiments in accordance with principles of inventive concepts, the lower cover 503 may have attached within it a housing magnet 512 and a magnetic trigger pairing sensor 514. The wheel mounting bracket 506 may have a wheel mounting bracket magnet 513 attached to the attachment of the monitor, analysis, and control system 10, including the attaching bracket 504, to the wheel mounting bracket 506 may yield a magnetic pairing of a housing magnet 512 to a wheel mounting bracket magnet 513. The aligning and/or pairing of these magnets may activate a signal that is detectable by a magnetic trigger pairing sensor 514. Such a device may be used to detect authorized/unauthorized removal of the monitor, analysis and control system 10 from the vehicle. Authorized removal may occur through the activation of an authorization code via the base unit, smart phone, and/or other authorized data submission method. The code will advise the unit to expect an unpairing of the magnets. Should an unauthorized monitor, analysis and control system 10 removal be detected, a system in accordance with principles of inventive concepts may respond in a variety of manners, including, but not be limited to: disabling the monitor, analysis and control system 10 and not allowing functionality, setting all ports to discharge, which may result in the system not maintaining pressure and sending alerts to pre-defined entities indicating that the system 10 is being/has been removed, for example.

The intermediate bracket 504 may also provide attachment and positioning for hose fitting 508 and/or other type fluid transfer fitting. Hose fitting 508 may provide an interface between the air/fluid transfer system within the monitor, analysis, and control system 10 and the hose assembly 18, which, in turn, may provide one of a variety of connections from the monitor, analysis and control system 10 to the tire pressure valve 21. In example embodiments, Fitting 508 may have a threaded end compatible with a threaded fitting on the hose assembly 18 and may be securely attached to the hose assembly and the lower cover 503, thereby providing an air-tight fluid conveyance from the monitor, analysis and control system 10 to tire valve 21. The lower housing may also provide attachment for air filtering system 600 and a battery system 700.

Air filter assembly 600 may precondition the air stream prior to being introduced to the inner workings of the system 10 and/or into the tire(s). Air near the road/intake area for the monitor, analysis and control system 10 may include both large and small particles of debris, contaminants, and/or water vapor that could have deleterious effects on the TMPIS system 10 and/or the tire assembly/ies. In example embodiments, air filter assembly 600 may remove unwanted contaminants from the air entering the system, thereby protecting monitor, analysis and control system 10 and associated tire/wheel assemblies.

In example embodiments, the filter assembly 600 may include a housing 601, which may include the following components: a housing element with a coarse or large filter screen/membrane 602 that may be fastened or molded to the housing 601; a fine filter element 603, and housing attachment features 604. The fine filter element 603, which may be may be hydrophobic and/or oleophobic, may be located adjacent to the coarse and/or large filter screen/membrane 602. The fine filter 603 may be securely fastened to the housing 601. Housing attaching features 604 may be molded or otherwise fastened onto the system 10 so that, in conjunction with seal 605 mounted on the filter housing, they could provide a secure retention of the filter assembly 600 to the lower housing 503. With the seal properly fitted to the housing 601, a moisture and air tight installation of the filter assembly into the lower cover 503 may be achieved. The lower cover 503 may have corresponding compatible features 509 to those on the filter assembly that, in combination with the filter housing, may ensure a secure attachment of the filter assembly to the lower cover 503.

In example embodiments in accordance with principles of inventive concepts, the filter assembly 600 may also be configured for removal from the monitor, analysis and control system 10, thereby providing the ability to perform periodic maintenance of the filter assembly 600 through its removal and/or replacement. To that end, the assembly may be designed to be removable and/or replaceable by a rotational movement of the filter housing 601 relative to a stationary lower cover 503. A quarter turn or similar rotation, and rearward extraction or similar type motion of the filter assembly relative to the lower cover 503 may be one such means of removal and/or replacement of the filter assembly 600.

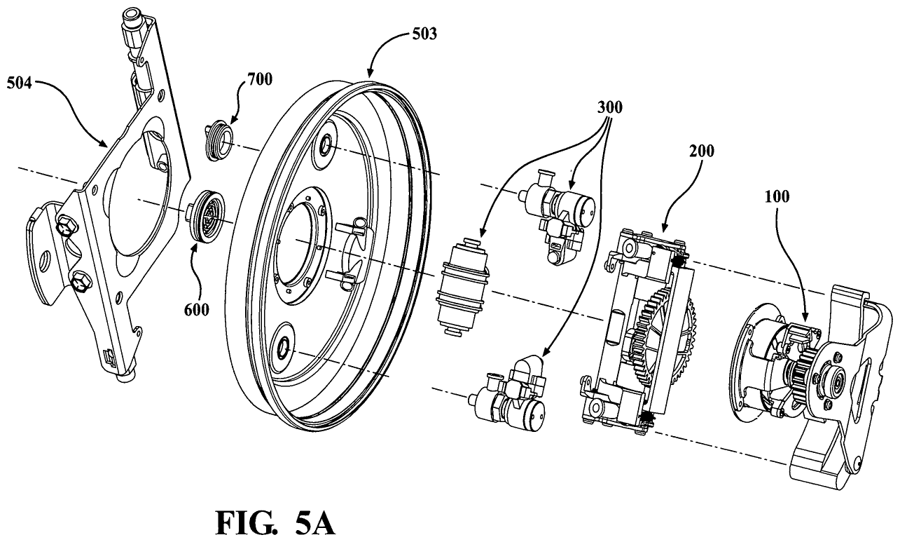

In example embodiments filter assembly 600 may introduce air into the filter with the primary flow of air entering the filter, tangential to the rotation and/or movement of the air entry port 606 into the filter assembly 600, as depicted in FIG. 6a. The air then may take a reversing path depicted by arrows B1 and B2 in FIG. 6a. This reversing path may reduce the speed of the entering air and, thus, reduce the amount of water carried in the entering air stream. This tangential port 606 and related air flow may also reduce the amount of debris traveling with the entering air.

In example embodiments, as the air enters the area adjacent to the initial filter membrane's 602 filter surface will be flowing in a tangential path relative to entry into the filter, thereby providing a means to clear contaminants from the filter surface as the air stream passes over it.

In example embodiments, the filter housing 601 is also configured to provide a means of water shedding. The air stream may carry with it, a percentage of water into port 606. As the velocity of the air stream is slowed by the previously mentioned reversed path, water will drop out of suspension and will travel as a result of centrifugal force back out of the entry port 606 (for example, as depicted in FIG. 6b, direction shown by arrow C). In example embodiments, that portion of the inlet air still carrying water may deposit it on membrane 602 as air travels through a hydrophobic membrane. The water left on surface will also collect at the outboard edge of the upper membrane surface, again resulting from centrifugal force (for example, as depicted by arrow D in FIG. 6b). Finally, the water thus collected will be drawn through negative pressure area 607 and, as depicted by arrow E, out of the filter housing 601, thus shedding the water collected.

In example embodiments in accordance with principles of inventive concepts an electrical storage device may be employed to store electrical energy for operation of a system's 10 controller or other electrical components. In example embodiments, the electrical storage device may be a battery (either rechargeable and/or non-rechargeable) and/or other electrical storage devices such as capacitors, super capacitors, for example. The electrical storage devices (also referred to herein, simply, as battery) may be used solely and/or as a supplement to electrical power generated by the monitor, analysis and control system 10 10 to provide power for elements of the monitor, analysis and control system 10 when the system's electrical generator is not generating power and/or when system power demands exceed the levels of power being generated by the monitor, analysis and control system 10's electrical generator.

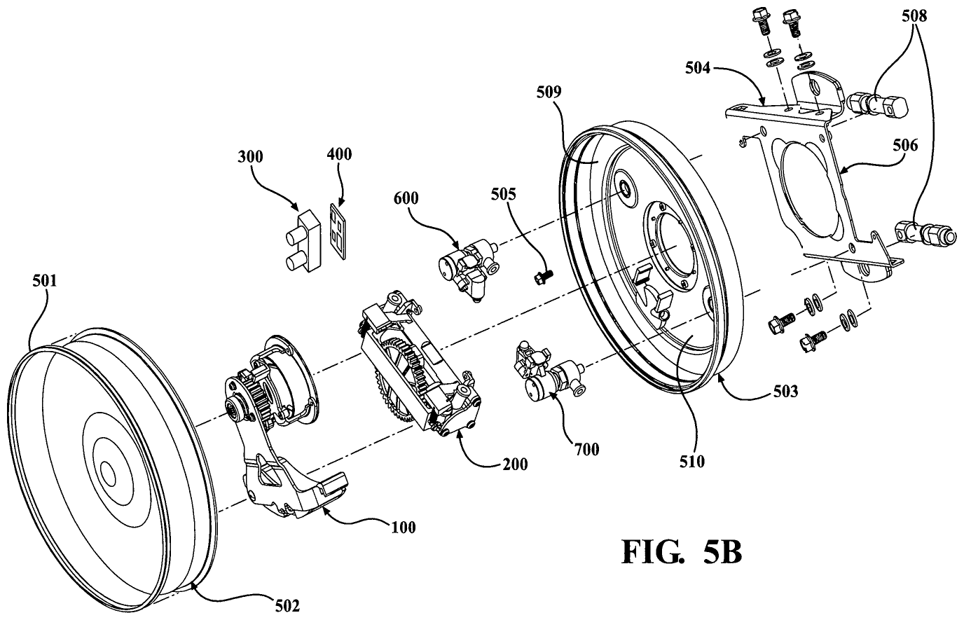

For example, a battery may be used to power control circuitry when the vehicle/system 10 is stationary and/or traveling at very low speeds (and, therefore, the system's electrical generator is not operating at its full capacity) to allow monitoring of system health and to provide other low-power system functionality. To that end, an example embodiment in accordance with principles of inventive concepts that includes battery resources is depicted in FIG. 7. In this example embodiment, battery system 700 may be mounted to the lower cover 503 in a similar manner to that of the filter assembly 600. In example embodiments that include a battery system 700, the battery housing 701 may contain a primary (single use) or secondary (rechargeable) battery(ies) 702 fitted into battery housing 701 in such a manner that it may have a positioning/contact spring 706 and electrical contact features 704) in the housing 701 that, when fitted to the lower cover 503 may complete a conductive circuit and provide transmit electrical energy to other elements of the monitor, analysis and control system 10. The battery housing 701 may also include sealing feature 703 and attaching features 705. Relative movement between the battery housing 701 and the lower cover 503 may provide a means of securing of the battery housing to the lower cover 503 and associated attaching feature 510. Proper placement of the sealing member 703 may provide an air- and moisture-tight attachment.

As with the filter assembly 600, it may be desirable from time to remove the battery assembly 700 to allow for the removal and/or replacement of the battery. In example embodiments in accordance with principles of inventive concepts, the battery housing 701 could is configured for removal from the monitor, analysis and control system 10 in a manner similar to the removal of the filter housing 601. That is, in example embodiments, the assembly may be removable and/or replaceable by a rotational or similar movement of the battery housing 701 relative to a stationary lower cover 503. A quarter turn and rearward extraction motion of the battery assembly 701 700 relative to the lower cover 503 may be one such means of removal and/or replacement of the battery assembly. With the battery assembly removed in this manner, the battery may be replaced. The housing may then be returned into the lower cover 503 with the seal 703 reestablishing the air and moisture tight seal (also referred to herein, simply, as a weather-tight seal) and reestablishing the battery connectivity via electrical connector 704, for example.

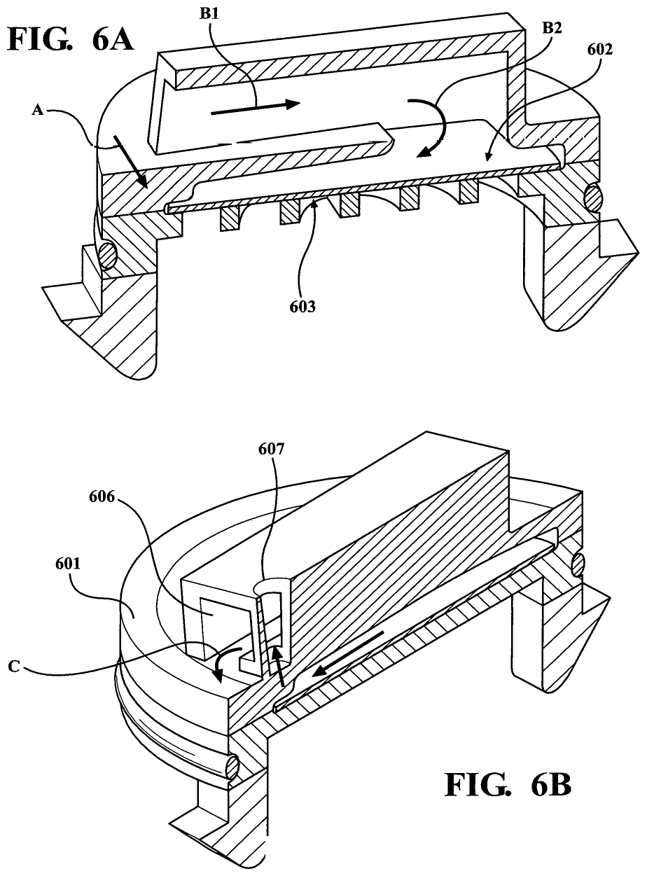

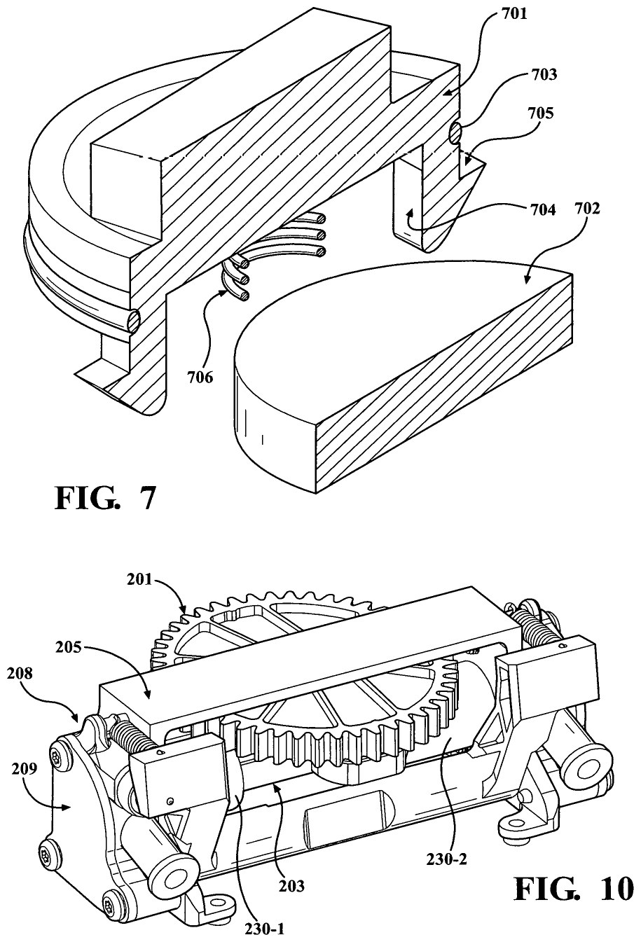

An example embodiment of a power generator in accordance with principles of inventive concepts in monitor, analysis and control system 10 is depicted in FIG. 5 as that portion of the overall system identified as elements contained in system 100, which may be referred to herein as the energy harvesting and power transmitting system. An isometric view of the energy harvesting and transmitting portion of the monitor, analysis and control system 10 is shown in FIG. 8. In FIG. 8, the relationship of the various components that, in example embodiments, constitute this portion of the assembly may be appreciated and will be described in greater detail, for example, in the discussion related to FIG. 9.

The harvesting of energy may occur with the relative rotational movement of the rotatable portion of monitor, analysis and control system 10 with respect to the inertial mass element 123 within the system 10. The rotation of the monitor, analysis and control system 10 may be as a result of being attached to the vehicle wheel assembly 14, which may be in a rotating state as the vehicle is in motion. The energy harvesting and power transmission member 100 within the monitor, analysis and control system 10 may be at a non-rotating state as a result of the inertial mass properties of the energy harvesting assembly 101 and the nearly rotational force free design of some of its elements. Relative motion between the monitor, analysis and control system 10 and its internal energy harvesting assembly 101 may provide two types of energy harvesting: mechanical and electrical energy.

Inertial mass unit 123 may include a number of elements as depicted in FIG. 8. The inertial mass unit 123 may be pivotable about an axis A. This axis A may be defined by a line created by the center point of the electrical power generator assembly 705 and the mounting of same into the lower cover 503 and a second point defined by the mounting of the generator shaft to the upper cover 502 via mounting elements as previously described within this disclosure. This axis may also be coaxial with shaft 715 and the axle with which the wheel-end unit is associated.

Inertial mass unit 123 may include the following elements: a radial support member 702, which may provide a radial member which may fasten and extend from a proximal attachment at/or about the generator shaft 715, the attaching bearing/bushing 713 and attaching socket slot plate 711, as previously described. Radial support member 702 may be configured extending from rotatable center axis A to a distal position which may have affixed to it a mass unit 701. The mass unit 701 configured to provide a sufficient gravitational inertial mass to maintain the inertial mass assembly 123 in a quasi-static position relative to the rotational movement of other elements of the monitor, analysis and control system device.

An alternative unit in which electrical power generation is not required may be created by replacing the generator assembly 705 with a shaft assembly (705a), not shown. Such an embodiment could provide the support shaft aspects of the electrical generator embodiment without the need for the added cost and complexity of the electrical power generation aspects of said embodiment.

The development of mechanical energy achieved through the relative motion of the energy element 123 and other elements of the monitor, analysis and control system 10 may employ a means of energy transmission for use within the system 10. The transmission elements may be as are shown in FIG. 8 for example. In FIG. 8, elevator housing 107 may be a circular element that may be securely affixed to lower housing 503 with a flange end attachable to the Lower Housing 503 using fasteners 120. Elevator housing 107 may also be positioned on the lower cover 503 so that the center of the elevator 107 may be coincident, or coaxial, with axis A. Elevator housing 107 also may have on its interior surface cam follower pin detail 118, which may be one or more in number. Pin(s) 118 may be molded into elevator housing 107 and/or affixed within the elevator housing 107 at prescribed locations and/or positions and may be of predetermined size and number such that they may interact with related cam surfaces and/or ramps 119 located on the exterior surface of elevator assembly 108.

The elevator assembly 108 exterior may be sized to fit within the elevator housing 107 and, when the housing 107 and elevator 108 are fitted together, may have pins 118 positioned to interact with the cam surfaces 119. The elevator assembly 108 may be rotatably activated from a position 1 to a position 2 or vice versa. The activation of the elevator 108 from position 1 relative to a fixed elevator housing 107 to a rotatable position about axis A to a position 2 within the elevator housing 107 may result in elevator assembly 108 cam surfaces 119 contacting elevator housing pins 118. This contact and/or interaction, may result in an elevation and/or a displacement along an axis A of elevator assembly 108 relative to elevator housing 107.

Elevator assembly 108 may have affixed, and/or may have axially related to it, a drive gear assembly 109 such that as elevator 108 moved along axis A from position 1 to position 2, may interact with drive gear assembly 109 and may result in drive gear assembly 109 moving along an axis A similar distance. The drive gear may move axially with the elevator 108 and both the drive gear and the elevator may be supported by generator shaft 715.

Drive gear 109 may be rotatably unconstrained by the elevator 108. Affixed and/or molded into the drive gear 109 may be one or a plurality of drive pins 110. These pins may move axially with the drive gear 109 and may interact with an attaching socket slot plate 711. Drive pins 110 may be assembled onto the gear a radial distance from the center of the gear and positioned such that they could interact with an attaching socket slot plate 711, with socket slots 721 in radial position and spacing so that they may correspond to the pins 110 within the drive gear 109.

As the drive gear 109 moves along Axis A, drive pins 110 contact attaching socket slot plate 711. As the monitor, analysis and control system 10, less the Inertial mass assembly 123 portion of the system 10, may be rotating with the vehicles wheel and tire assembly, and the inertial mass assembly 123 may be rotationally quasi-static due to the inertial effects of its mass, and, as a result, there may be a relative rotational motion between the drive pins 110 and the socket slots 721 within the attaching socket slot plate 711. The rotational relative motion of the pins 110 and the socket slots 721, in conjunction with the axial movement of elevator assembly 108 toward the attaching socket slot plate 711, may result in axial coupling of drive pins 110 and socket slots 721 in attaching socket slot plate 711.

Coupling with attaching socket slot plate 711, being affixed as part of the inertial mass assembly 123, may result in inertial mass assembly 123 constraining the rotational motion of drive gear assembly 109. The constraining of the gear 109 by the inertial mass assembly 123 may cause a relative motion between the drive gear assembly 109 and the other elements of the monitor, analysis and control system as the coupling of the drive pins 110 and socket slots 721 occurs. In example embodiments in accordance with principle of inventive concepts, this provides a means of transmitting mechanical force and/or torque from the inertial portion of the system to mechanical elements that may be coupled to the drive gear assembly 109.

In example embodiments in accordance with principles of inventive concepts, electrical energy harvesting within the monitor, analysis and control system 10 may be a result of a similar relative rotational motion. An electric motor may output a voltage when it is mechanically rotated, operating as electrical generator. In example embodiments in accordance with principles of inventive concepts, an electric motor may be used in this fashion to generate electrical power for a monitor, analysis and control system 10. In example embodiments, all, or a portion, of inertial mass assembly 123 mechanical rotational energy may be used to drive a motor, such as a stepper motor, to generate the voltage and electrical current desired to provide electrical power needs of a monitor, analysis and control system 10 or similar device. Such a configuration may use a stepper motor 105 with the stator and coils held fixed as part of the housing 714 and the rotor and shaft 715 held fixed to the inertial mass assembly 123 and freely rotating relative to the housing 714, for example. Other motors, such as a Brushless DC (BLDC) motor, shunt motors, series motors, permanent magnet motors (PMDC), compound motors, AC motors such as induction and synchronous motors and hybrid motors such as hysteresis motors, reluctance motors, etc. or any other type of electrical motor, are contemplated within the scope of inventive concepts to generate electrical power.

In example embodiments in accordance with principles of inventive concepts, the pumping action of the monitor, analysis and control system 10 and associated generation of fluid pressure may employ elements of the energy harvesting and transmission system 100, the pumping system 200, the housings 502 and 503, and the filtering system 600. In example embodiments, the drive gear 109, in conjunction with portions of the energy harvesting and transmission system 100, when placed into relative rotating performance through the interaction of drive pins 110 in drive socket slots 721 activates the pumping system 200. The transmission of mechanical energy from the inertial mass unit 123 through the drive gear assembly 109 is affected through a coupled association that provides a power connection to a pumping system 200, an example of which is depicted in FIG. 5.

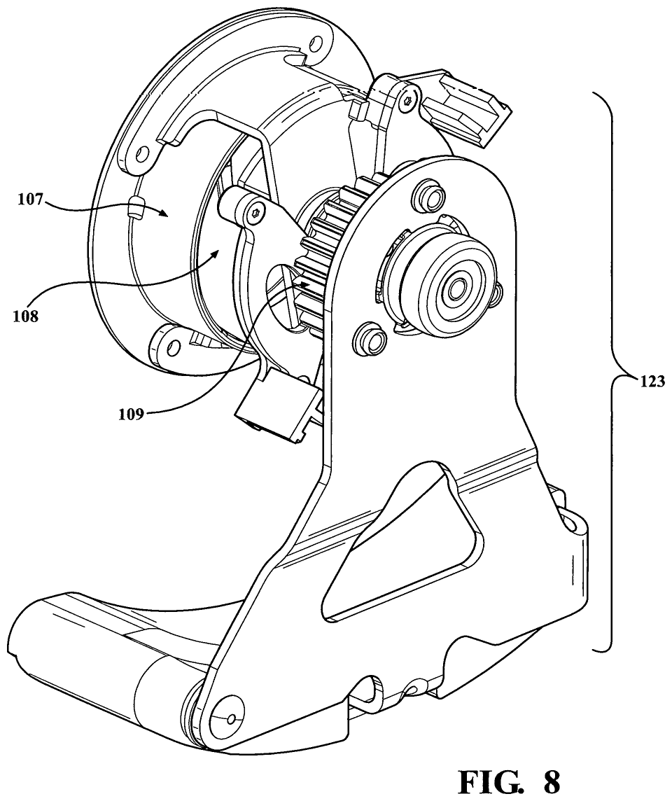

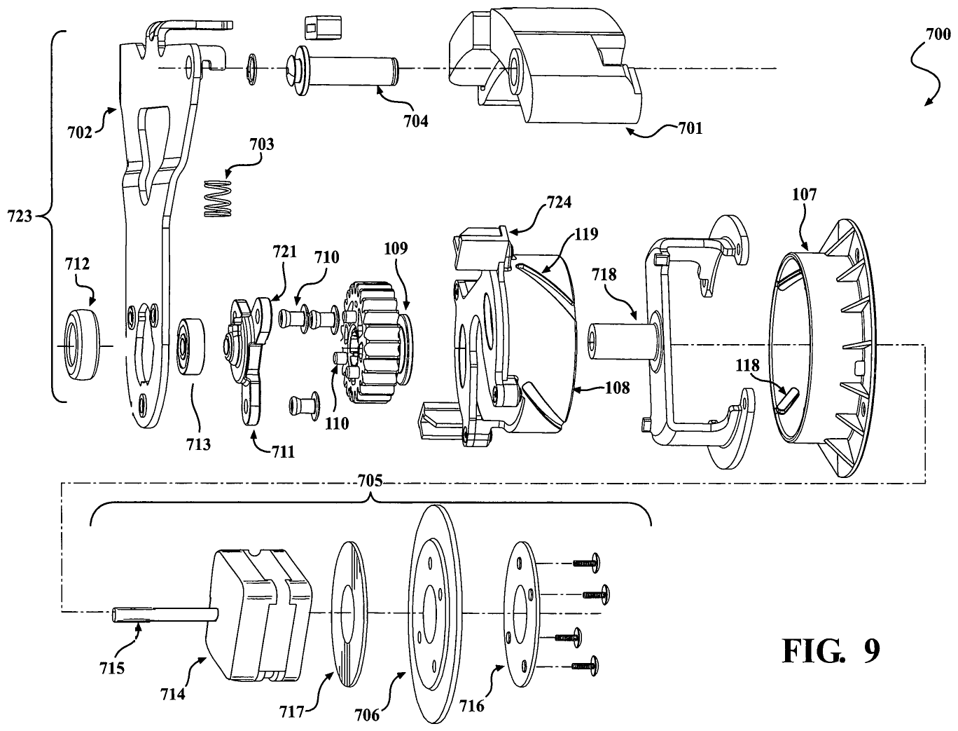

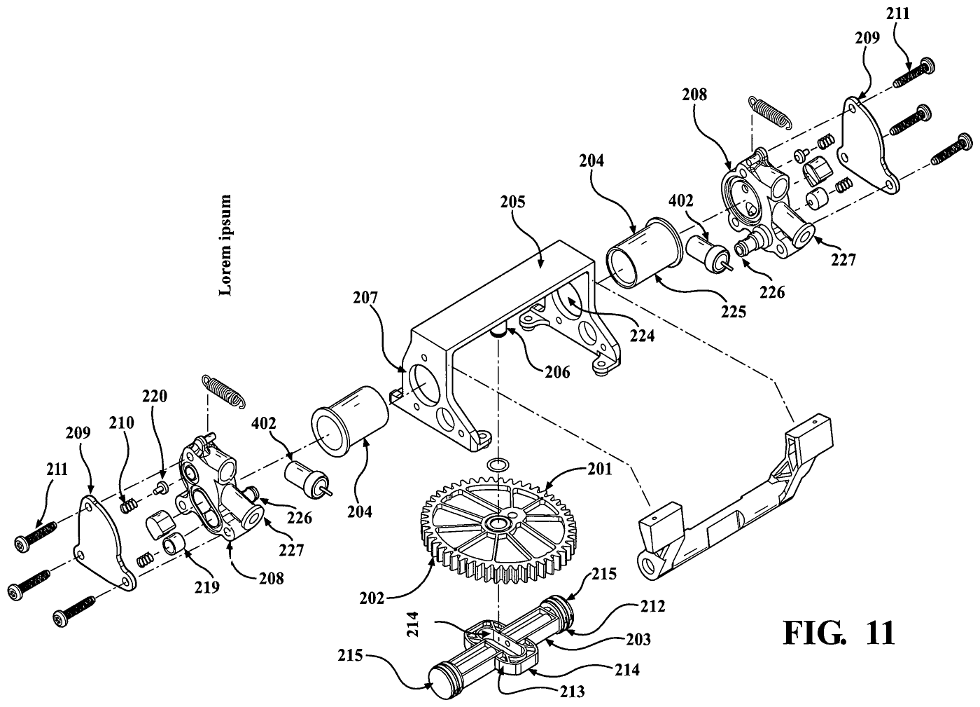

FIGS. 11, 12a and 12b provide further detail of an exemplary pumping system 200 of FIG. 10, with an exploded view of elements of an exemplary system being shown. The pumping system 200, when coupled to drive gear 109 may include a frame unit 205. The frame unit 205 may have accommodations at each of its furthest extensions to provide a means for attachment of cylindrical elements. These cylindrical elements 204 may fit into the frame such that the centerline of each of the cylinders is aligned and creates pumping axis C. The cylinders may also be symmetrically positioned on the pumping axis C, each at opposite extended positions of the frame. The cylinders 204 may have an outer diameter that is similar in geometry to voids within the frame that are centered on the pumping axis C axis. The cylinder(s) 204 may also have flange element at the distal end from the center of the frame 205, which is larger in diameter than the void into which the cylinder is fitted into the frame 205. The flange element provides a means of stopping and/or positioning the cylinder 204 to the frame 205.

In example embodiments, cylinder head 208 is positioned adjacent to each of cylinders 204. Cylinder head 208 may have a depression that corresponds to the external perimeter of the cylinder flange 225. The cylinder head 208 may include both intake ports 226 and outlet ports 227. The cylinder may be constructed to include valving within the cylinder to allow normal operation of a pumping system. The cylinder and cylinder head may include a sealed interface and may be secured to the frame assembly using cylinder head fasteners 211, which may retain the cylinder 204, the cylinder head 208 and a cylinder end seal plate 209.

In example embodiments a piston assembly 203 is fitted into the cylinders. The piston assembly 233 has at opposing ends fitted piston head members 215 that fit within the cylinders 204. Piston assembly 233 may be constructed from multiple materials, with the piston heads 215 of compatible material to the cylinder 204 to allow for both heat dissipation developed as a result of pumping of fluid, and expansion/contraction of the cylinders 204 and piston heads 215.

The piston heads 215 may also be constructed with piston ring materials 212 constructed and placed on the piston head 215 external periphery such that during the relative motion of the piston head 215 to the cylinder 204 along pumping axis C, the piston rings 212 create a dynamic seal facilitating the development of increasing pressure within reducing volume 216, as described by the interior wall of cylinder 204, the cylinder head 208 inner chamber surface, and the top surface of piston head 215 as it moves along the pumping axis C toward the cylinder head 208. The movement of the piston heads 215 may occur as a result of movement of the connecting rod 203 located between and attached to both piston head 215s. The connecting rod 203 may be constructed from a material different from the piston head 215s, providing both light weight construction and lubricity between the connecting rod 203 and other interfacing surfaces.

The frame element 205 may have provisions to accommodate the positioning of a pumping system gear 201. The frame 205 may have a circular pin 206 molded and/or otherwise fastened to the frame to provide a means for placement and support of a pumping gear 201 such that it could interact with a drive gear 109 and provide a means of torque and/or force transmission when the drive gear 109 is coupled to the mechanical energy harvesting system.

The pumping gear 201 may be circular in periphery and have a rotatable position such that the periphery of the gear rotates about its geometrical center and may have a corresponding drive gear 109 that is also circular and also has a geometrical rotatable point in the center, such that with compatible gear teeth on the periphery of both gears, the meshing of the two gears provides a means of transmitting torque for the pumping and related compression of contained fluid.

The transmission of force from the pumping gear to the piston assembly, may be by means of an integral and/or securely fastened yoke pin and bearing 202 positioned onto the pumping gear. The yoke pin and bearing 202 may be positioned onto the gear, such that rotation of the gear will result in the yoke pin and bearing 202 tracing a prescribed circumferential path. The piston connecting rod 203 may have a void at/or near its center the surface of which may have a cross hatch surface treatment and/or a hardness treatment. The yoke pin bearing 202, in conjunction with the yoke surface 214 may result in reduced system drag and significantly improved wear performance vs. a yoke surface 214 not having such attention. The yoke void 213 may have a width approximately the diameter of the yoke pin bearing 202 and a length approximately equal to the distance of the diameter prescribed by the yoke pin bearing 202. The yoke pin bearing 202 may be fitted to the connecting rod 203 within the described yoke void 213. This could provide the means of transmitting the rotational torque/force into a translational force to provide the desired pumping action of the piston to the cylinder assembly by the yoke pin bearing 202 contacting the yoke surface 214 as the gear moves in the rotational direction which then may cause, through contact between the gear yoke surface 214 and the yoke pin bearing 202 translation of the piston connecting rod 203 and piston 215.

The relationship of the gear diameters may be such that they have ratios that are 1:1, or may have ratios that are other than 1:1 to facilitate a desired mechanical advantage to achieve preferred pumping torque/force and/or fluid volume delivery performance. To further optimize desired torque/force transmission, the gears may have configurations other than circular and/or the rotatable position may be other than the geometrical center of the gear. An exemplary embodiment may include a drive gear 109 where the rotatable center may be biased away from and/or off of the geometrical center of the drive gear 109. Such an off-center location of the drive gear center could result in the excursion of the periphery of the gear to be other than circular, and may be of a shape which could be characterized by an ellipse. The pumping gear 201 may be configured to have a shape similar to the shape prescribed by the drive gear 109, such as an ellipse, and may be positioned relative to the drive gear such that both gears will have coincident or matching paths as they rotate. Such a configuration could allow the benefit of a potential mechanical advantage at/or near the high compression points of the pumping system and/or could reduce the torque and/or force fluctuations experienced during the pumping action, Additionally, such a configuration could provide a more constant, lower torque/force demand, due to the varying mechanical advantage experienced by such a configuration. Although the offset drive gear with elliptical pump gear represents one exemplary configuration, varying the shape and rotational center of each and/or both of the gears could provide alternative torque/force configurations and could be constructed to provide optimal and/or system preferred operational performance parameters.

The described configuration/(s) may allow the mechanical energy harvesting unit to connect via the drive gear 109 to the pump gear 201, which may provide sufficient force to drive the pumping system 200. The drive of the pumping system via pumping gear 201 may result in fluid, such as air and/or an alternative fluid which may be atmospheric or possibly pressurized to flow through the filter system 600, resulting in the conditioning of said fluid and/or air. The flow may result from a negative pressure in the cylinder cavity resulting from an increasing of the cylinder volume 216 from a minimum volume 218. The increasing of the volume 216 occurring as the piston surface 215 moves away from the cylinder head 208 as a result of the yoke surface 214 and yoke pin and bearing 202 interaction as the pumping gear 201 rotates and causes the predetermined prescribed path of the yoke pin and bearing 202 until the yoke pin and bearing 202 reach a position which may describe a maximum distal position relative to a cylinder head 208, which may describe a cylinder maximum volume 217. The Volume 216 can change from a maximum volume 217 to a minimum volume 218, and vice versa, as the yoke and pin follow their prescribed path.

Intake valve 219 and outlet valve 220 in cylinder head 208 may define the pressure of the volume of fluid within the volume 216. The intake valve 219 may receive fluid from intake reservoir 221 through filter system 600 providing conditioned fluid as described into volume defined by piston face 215 and cylinder end cap 209 and/or may receive fluid from an alternative source such as a piston/cylinder set within the system. The intake reservoir 221 may be at atmospheric pressure or some other pressure. The piston face may move from a position which defines volume near/or about minimum volume 218 to and/or through the traverse of piston surface 215 to a position near/or about a position defining maximum volume 217. As the piston then begins to move from the maximum volume position to the minimum volume position, the intake valve may close. As the minimum volume 218 is approached the outlet valve 220 in the cylinder end cap may open and release pressurize fluid into outlet reservoir 222. The outlet reservoir 222 may be a hose assembly 18 leading to a tire or may be an alternative intermediate reservoir and/or other reservoir and/or switching element.

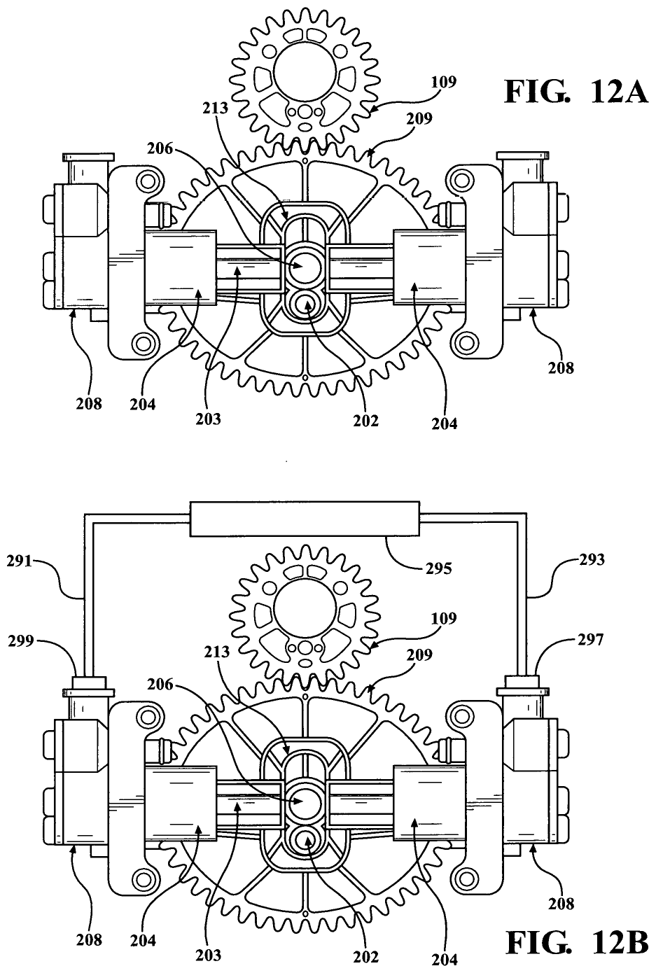

A switching system 300 is referenced in the system view in FIG. 5 as part of the monitor, analysis and control system 10. A schematic of a mechanical embodiment of a switching device 301 is shown in FIGS. 13a and 13b. An exemplary embodiment may include a regulator assembly 302 that mechanically monitors input pressure and a pressure activated switch 303, a fluid transfer valve 404, and an equalizer valve assembly 340. In example embodiments this system provides the appropriate activation and/or deactivation of the mechanical transmission system that results in the transmission of torque/force to the fluid pumping portion of the device and/or other mechanical force/torque demand portion of the system.

In example embodiments mechanical activation/deactivation may be accommodated by the pressurization of switch 303 causing the movement of activation/deactivation member 334. Activation/deactivation member 334 applies a primarily tangential force in the clockwise or counter-clockwise direction to the elevator element 108, which may result in rotation of elevator element 108. Rotation of elevator element 108 may yield movement of the drive gear 109 containing drive pins 110, possibly resulting in the coupling of the drive gear connecting of the torque/force transmitting system 100 and mechanical torque harvesting. A similar movement of mechanical activation/deactivation member 334 in the opposite or reverse direction may result in decoupling and/or deactivation of the mechanical force transmission by moving the aforementioned elements in the opposite direction which may result in elevator assembly 108 moving in a direction which may result in the decoupling of drive pins 110 and the associated uncoupling of the torque/force transmitting system 100.

In example embodiments the pressure activated switch 303 with activation/deactivation member 334 may fit onto a surface of fluid transfer valve 404 which may be fitted to regulator valve 302. For embodiments in which a fluid transfer valve 404 may not be present a spacer may exist between the valve 302 and the switch 303 facilitating the affixing and associated proper position. The actuation switch may be adjacent to the elevator assembly. The pressurization of switch 303 may be configured to accommodate an activation/deactivation member 334 internal to the housing 382. The member 334 constructed within the actuation housing 382 such that the member may be able to traverse from a contracted first position 386 to an extended second position 387.

The member 334 may have accommodation at its distal end from the actuation housing 382, and adjacent to the elevator assembly 108, for attachment of the member 334 to a member attaching detail 124 of the elevator assembly 108. The distal end of member 334 may be attached to elevator attaching detail 124 by direct contact and/or other means which may convey the member 334 principally linear motion into the tangential activation of the elevator 108. The attachment of the member 334 to the elevator assembly 108 may result in the movement of elevator assembly 108 should the member 334 move from a first position 386 to a second position 387 or from a second position 387 to a first position 386. The actuation housing 382 may/or may not also accommodate a biasing member 390 that may act between the member 334 and the actuation housing 382. The biasing member 390 may cause the member 334 to have a bias position; this bias position may be toward the retracted position and/or first position 386 as relates to the actuation housing 382. The bias position may alternatively be toward the extended position and/or position 2 387. Such a biasing element 390 could be a compression spring, an extension spring, or other like biasing element, for example.

The activation housing 382 may also have accommodation to include a plurality of orifices entering into the internal volume of the activation housing 382. One or more of these ports/orifices may be designated intake ports 391. One or more of the ports/orifices may be outlet and/or exhaust ports 392. Fluid entering the intake port 391 may result in the increase of fluid volume 393 between the piston surface 394 and the activation housing end surface 395. This increase in volume may result in the piston (member) assembly moving from a first position to a second position or vice versa. The exhaust of fluid through the outlet and/or exhaust port 392 may result in a reduction of volume within the area between the cylinder and a surface of the activation housing assembly. This, in conjunction with biasing member 370 forces, may result in movement of the piston (member 334) from a second position 387 to a first position 386, or vice versa. The activation assembly may be activated by the application of pressure within the piston, as described, or may be activated by a separate mechanical switching device, and/or an electrical switching device 361, depending upon the control strategy or strategies employed.

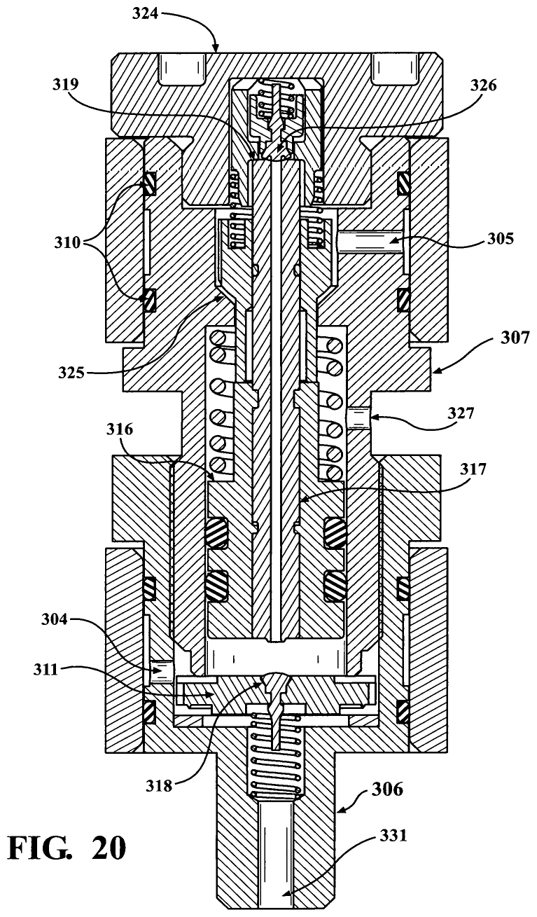

An exemplary embodiment of a mechanical switching device 301 may be similar to the illustration depicted in FIG. 20, which shows the device, for clarity, in section view. The valve 301 may include three or more entry/output ports. These ports may include; a lower or tire port 331, a pumping and/or pressure port 304, and an exhaust and/or release port 305. These ports may be associated with a pressure sensor valve body lower 306 and/or a pressure sensor valve body upper 307. The lower port 331 may be an integral part of the valve body lower 306 or may be a separate member being fixedly attached to the valve body lower 306. The pressure port 304 and release port 305 may be constructed in a similar manner. Each port and/or orifice may be constructed with an integral circular element 308 with an inner diameter sufficient to fit around a similar detail on the pressure sensor valve body upper 307 and/or lower 306. The valve body lower 306 and/or upper 307 may have one or a plurality of groove(s) and/or depression(s) 310 on its outer surface. The grooves 310 may be constructed in such a manner as to accommodate the placement and/or positioning of O-ring(s) 309 onto the valve body upper 307 and/or lower 306.

The valve body lower 306 and/or the valve body upper 307 may each have installed on their respective external surface one and/or a plurality of O-ring(s) 309, for example. The pressure port 304 may be assembled onto the lower valve body 306 by sliding the band element 308 of the pressure port member 304 over the lower valve body 306 and/or the O-ring(s) 309 until the O-ring(s) interact with the outer band 308. The interaction of the O-ring 309 with the lower valve body 306 and the outer band 308 may create an air and/or fluid tight seal. A similar assembly may be employed, using the upper valve body 307, the exhaust port member 305 with its integral band 308, and O-ring(s) 309, also possibly resulting in air/fluid tight sealing.

The ports 304 and/or 305 each in this assembly may have the capacity/capability to be rotated within the set elevation height defined by the interface of the band 308 and the O-rings 309 to achieve a desired port orientation and still maintain the set air/fluid tight seal. The band 308, O-rings 309, and valve housing diameters for illustration were not defined as differing in respective diameter, although such a condition is anticipated within the scope of inventive concepts. The valve body lower 306 and the valve body upper 307 each also are constructed with a central cavity 311. These circular cavities may also have one or a plurality of radial orifices 317 leading to an external surface of the valve body.

A pressure valve 313 may be constructed such that it may have an external circular surface with valve O-ring groove(s) 314 that may accommodate one or a plurality of valve O-ring(s) 315. The valve may also have in its construction an external primarily circular surface 316 that may provide a contact surface for a biasing member. Internal to the valve, there may be a void and/or passage 312 leading from/or about the lower end surface 318 of the valve to and/or about the upper end surface 319 of the valve. Adjacent to the lower end surface 318 may be loosely affixed a valve orifice seal 330. The valve orifice seal 330 may be circular in shape and may provide an interface between the valve lower end contact surface 318 and the lower port 331. The valve may also have an additional external approximate circular valve surface 320 that may be located above the valve O-ring groove(s) 314. The pressure valve 313 may be assembled into the upper valve body 307 and the lower valve body 306 such that a biasing member 332 interacts between the valve biasing member contact surface 316 and the upper valve body 307 in such a way as to bias the valve in the direction of the lower valve body 306.

A circular exhaust valve member 322 may also be assembled onto the valve. The exhaust valve member 322 may also have an exhaust valve biasing member 323 that may interact between the exhaust valve and the valve assembly cap 324. The exhaust valve biasing member may bias the exhaust valve toward the upper valve body valve seal surface 325. The exhaust valve 322 interaction with the upper valve body seal surface may result in an air/fluid tight seal. There may also be a fluid/air drain 327 within the upper valve body 307, such that it may be contained above the valve O-ring(s) 315 and below the exhaust valve seal surface 325. The valve assembly cap 324 may have affixed to it stem seal 326. Stem seal may be an elastomeric member and/or may be a seal with a biasing member, in either case, possibly providing a seal to the valve center orifice 312 if so presented.

The monitor, analysis and control system 10 may include a primary pressure sensing valve 302 and a state valve 303. The pressure, when at or over target pressure, will maintain a closed valve state and not transmit pressurized fluid to the state valve 303. When below targeted pressure, the pressure sensing valve 302 may move to an open valve position and provide pressure to the state valve 303, with state valve 303 capable of being in a first position or a second position. The first position of state valve 303 corresponds to a Pressure Sensing Valve 302 being in a closed or unpressured position, and a second position corresponds to Pressure Sensing Valve 302 being in an open or pressure position. The state valve 303 may be coupled to the elevator element 108 through elevator detail arm 308, integral to elevator arm 108, by way of a rotatable pivot element 307. The valve may also have an extendable and/or retractable arm 309 moving from a first position to a second position.

The pressure sensing valve 302 may include an inlet port 304 connected to reservoir 20 via tubes and/or hoses or other types of fluid conveyance to tire(s) 19. In example embodiments, the system may employ one or more pressure sensing valves 302. The pressure sensing valve 302 may be dedicated to assessing a singular tire 19 or reservoir 20 or a single pressure sensing valve may be used to sense multiple tires 19 or reservoirs 20. The pressure sensing units may independently assess individual tire/reservoir pressure state and when the pressure is in a designated target range the pressure sensing unit may cause the activation of the state valve 303. Having multiple pressure sensing valves 302 may allow independent activation of the pumping system, as compared to a comingled assessment when using a single pressure sensing valve 302 for the entire monitor, analysis and control system 10. The separate assessment allows the use of low and high target shut-offs on the system, as well as other benefits.

The pressure sensing valve 302 may have one or more opening and closing threshold pressures, which may result from the action of one or more mechanical biasing device(s). The pressure sensing valve 302 may provide a means of sensing a variety of levels of pressure within a reservoir 20 and/or tire 19 and provide indicators within the system that may enable a variety of actions by monitor, analysis and control system 10. For example, the pressure sensing valve may sense a tire that is below a targeted pumping threshold level. Such a condition could occur with a tire that has experienced a significant loss of air from a tire blow-out and/or similar event and/or other event. Such a low pressure could be sensed within the valve and, because the pressure is below a pumping threshold, the system would prevent pump activation for that tire. The valve could experience pressure from the tire through the tire orifice 331. Air entering the tire orifice 331 may encounter the pressure sensing valve 302 and exert pressure on the sensing valve 302 commensurate with the pressure in the tire. In the case where the pressure in the tire may be below the low pumping target, the pressure will not be sufficient to lift the valve 313. In this manner, air pressure from the tire orifice 331 is prevented from providing any influence on the other areas of the valve unless the pressure in the tire orifice reaches the low threshold target value.

When the valve reaches the lower pumping threshold, it may have the remainder of the valve in the following state. The air may then only travel up the center orifice 312 into the upper valve body 307. The exhaust valve 322 at this state is in a biased position resulting from exhaust biasing member 323. The exhaust valve 322 biased in this position may cause the valve orifice seal 330 to contact both the valve lower surface 318 and the tire orifice 331 and may seal the tire air from entering the valve. This may also result in not allowing any activation signal to occur from this pressure sensing valve 313 to the activation switch 303.

The valve also may sense a pressure level at target pressure. This condition would not warrant pump activation. The pressure from the tire at the designated target pressure would enter through tire orifice 303. The force resulting from the tire air pressure applied to valve 313 and valve orifice seal 330 may position the valve in an elevated position. The elevated valve position may be the result of the air pressure on the lower end of the valve counteracted by forces from a biasing member 332 acting in an opposing direction. The biasing member 332 acting between valve biasing member contact surface 316 and upper valve body 307. The biasing member 332 may be tuned to a target load condition such that, the target force may correspond to a set distance. Just prior to achieving the designated set distance, the valve upper edge surface 319 may contact elastomeric valve upper orifice seal 333 sealing and possibly precluding the potential flow of fluid/air from the upper valve body 307 cavity to the lower valve body 306 cavity or vice versa.

Additionally, with the valve reaching target distance the exhaust valve contact surface 320 on the pressure sensing valve may contact and move the exhaust valve 322 off of exhaust valve seal surface 325 located on upper valve body 307. The separation of the exhaust valve seal 322 from the seal surface 325 may allow the escape of contained fluid/air pressure from the cavity through the air drain orifice 327. The cavity at that state also drains pressure from the exhaust orifice 305. The exhaust orifice, leading to activation/deactivation switch 303, may cause the switch to exhaust and thus the activation/deactivation biasing to a pump deactivation state, which will be described in greater detail below.

A third condition, one in which the pressure levels may be above a lower pressure pumping level threshold yet not sufficiently elevated to achieve a desired target pressure, may one in which the pumping system is activated. In this condition, or state, the air pressure entering tire orifice 331, is between the low pumping threshold pressure and the target pressure, the pressure sensing valve 313 may then be located above the sealing of lower orifice surface 318 position (described related to the low pumping pressure threshold), and below the position achieved when target pressure is achieved (described related to the target pressure condition). With the valve in this position, the lower valve body 306 cavity is open to both the tire orifice 331 and the pumping orifice 304. The pressure from the tire orifice 304 flows through the valve internal orifice 312 and pressurizes the upper valve body 307 cavity, also possibly pressurizing through the exhaust orifice 305. Pressurizing the switching valve 303 may result in the activation of the pumping system 200 and the pumping system providing additional compressed air/fluid from the pumping system through the pump orifice 304 into the lower valve body 306 cavity and into the tire orifice 331.

The pumping system will continue to pump additional compressed air/fluid into the system to the tire and/or the lower valve body 306 orifice and with the increased pressures, the valve will continue to raise in position until the valve nears the target pressure related to a target set distance (as described in connection with the biasing member 332). As the set distance is neared, the valve will contact the valve upper orifice seal, which will contact the valve upper surface 319, thereby preventing fluid/air flow through valve orifice 312. The pressure sensing valve exhaust contact surface 320 will also contact exhaust valve 322 and dislodge it from upper valve body seal surface 325, allowing upper valve body 307 cavity pressurized fluid/air to exhaust or drain through drain orifice 327. The same would also occur through exhaust orifice 305 as the path is unimpeded. With non-pressurized air in the activation/deactivation switch 381, the bias member 370 in the valve will bias the system to deactivate and will shut off the pump.

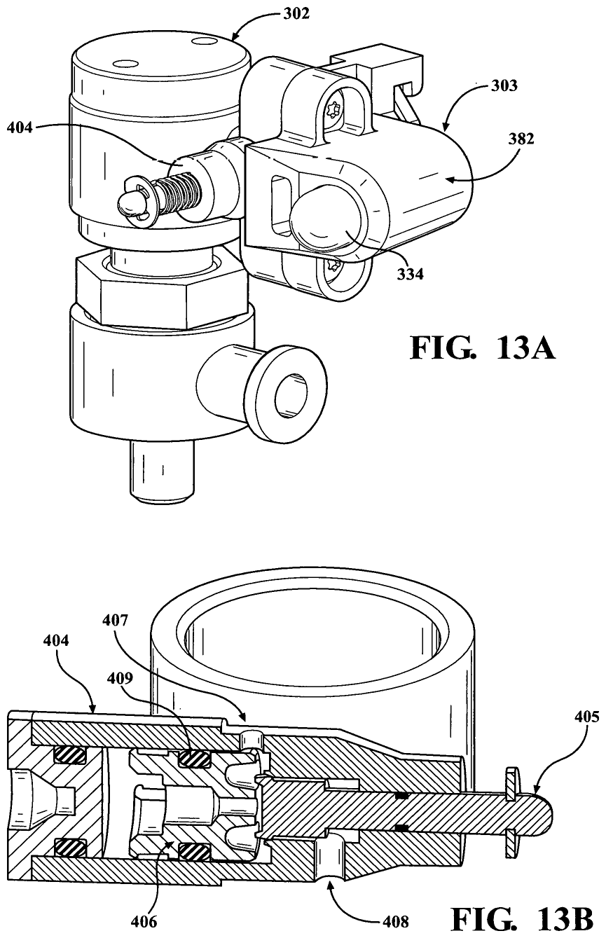

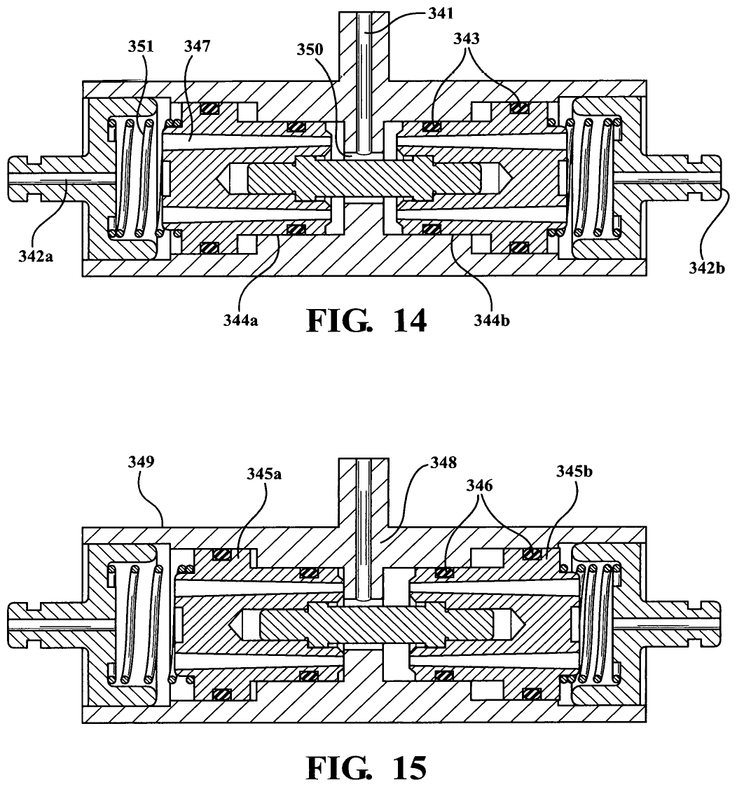

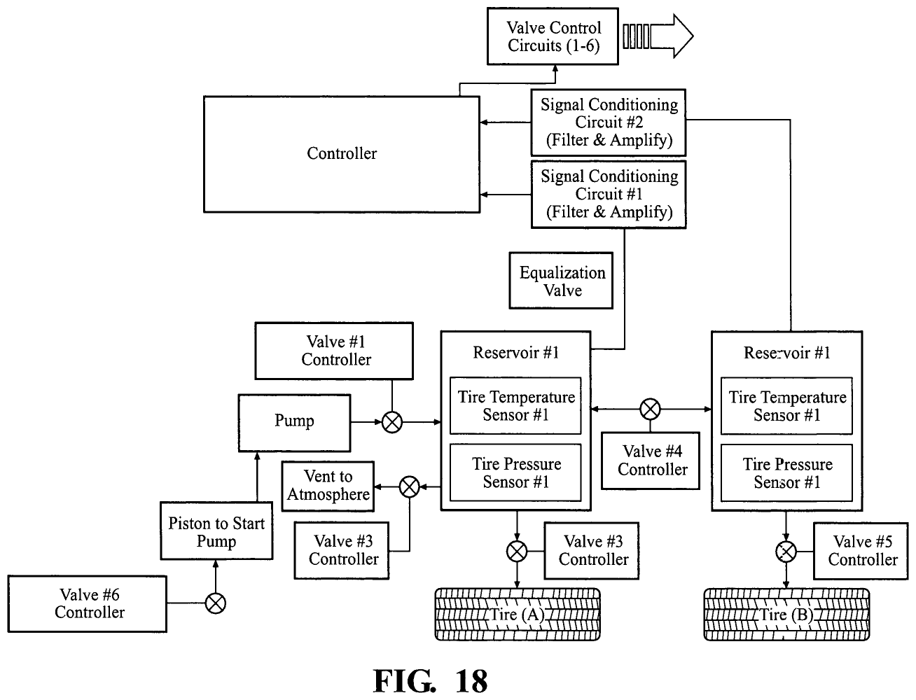

The system may also have an equalizer valve assembly 340, illustrated in FIGS. 14 (equalized pressure view), 15 (higher pressure of left), and 16 (exploded view) that provides a means of equalizing the air supplied from the pump assembly 200 to the tires, to thereby allow near equal pressures within the two tires of a dual tire embodiment. FIG. 18 provides an overview of control, pumping, valves and tires as they relate to inflating, deflating and equalizing pressures. This equalization may result from the equalizer valve 340 receiving air from the pump assembly 200 and distributing the air to two tires such that pressures are equalized. To that end, an equalizer valve may have an equalizer housing 349 which contains pump orifices 341-1 and 341-2, each possibly corresponding to input from one of each of pumping elements of the pumping system 200, say pump 230-1 and/or 230-2, respectively. These orifices 341-1, 2 may have air that flows from pump assembly 200, and more specifically pumps 230-1 and/or 230-2 and may possibly exit the valve housing 349 through one and/or both of tire inlet orifices (Tire A inlet orifice 342a and Tire B inlet orifice 342b). The pump orifice air may be introduced to two cavities, Tire A cavity 344a and Tire B cavity 344b, via a center wall 348 within the equalizer valve housing 349. Each cavity may have an equalizer piston within the respective cavity 345a and 345b. The piston may have a proximal end near the pump inlet orifice 341-1, 2 and/or wall 348 and a distal end that may be near the tire orifice 342. The pistons may each have a biasing member at their respective distal ends, equalizer piston biasing members 345a and 345b. These biasing members may each bias their respective piston toward the center wall 348.

The pistons may each have one or more grooves 346, (two in an example embodiment), on their perimeter diameters that may form a slot into which each may receive an O-ring 343. These O-rings, acting between the piston 345 external diameter and its respective equalizer cavity 344 periphery to form a seal at their adjoining surfaces. The pistons 345 may each also have one and/or a plurality of longitudinal air passages 347 running through them, from a proximal to a distal end on each. These air passages 347, on the proximal end may be situated to interact with a disc seal 351-A,B on each side of the wall 348 internal to the equalizer and/or to the wall itself should seal discs not be present. The air entering into pump orifice 341-1, 2 may interact through center wall passage 350 with the proximal ends of the pistons 345.

Piston biasing members 351, in conjunction with tire pressure exerted through tire orifice 342, may exert a combined force on the distal end of the piston 345. Each of the pistons' respective force will be counteracted by the air pressure/force entering from pump orifice 341-1, 2. The forces may cause compression of one of the piston biasing members 351 due to a possible unequal force balance, should the tires be exerting differing pressures/force on the distal ends of the pistons 345. The piston 345 on the side of the equalizer associated with the lower pressure tire will move toward the tire orifice, compressing the biasing member until either the piston reaches end of travel within the equalizer housing 349 and/or a force balance as a result of the increasing force exerted by the biasing member as it is compressed is achieved.

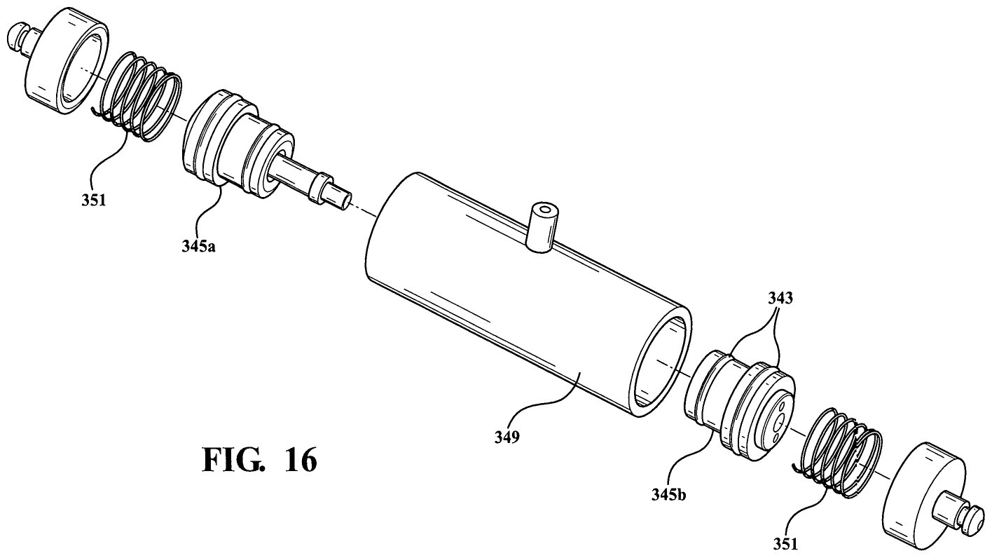

One configuration resulting from the described force interaction, as depicted in FIG. 16, may be that one piston, say 345a being on the side with a higher and/or target pressure in, say, Tire A, may be moved to the center wall 348 covering center wall air passage 350 inhibiting air flow through air passage 347a in piston 345a and to tire A. Conversely, the other piston, say 345B being on the side with a low pressure in, say, Tire B, may be moved away from center wall 348, exposing center wall air passage 350 to air passage 347b in piston 345b with air then flowing into Tire B. The flow will continue in said manner with pressure on the side of tire B continuing to increase, and, as a result, the pistons may move from the described position until a prescribed difference in pressures exists between the two tires, at which point air may flow through the air passages in both pistons, thus equalizing the air pressure in each of the tires. If the tire pressure in tire A and Tire B do not adjust to within the prescribed difference, the passages may not be cleared.

Additionally, the pressure equalizer valve may have fitted to the pump orifice inlets 341-1 and 341-2 single direction flow devices 352-1 and 352-2, respectively. These single direction flow devices may be installed to only permit air flow to enter an equalizer and/or other flow directing device to said equalizer valve assembly 340, one or more tires 19, or reservoirs 20, through the pump orifice 341-1 and/or 341-2. The orifice restriction may prevent flow from the equalizer valve assembly 340, one or more tires 19, or reservoirs 20, to flow toward pump 230-1, 2. These orifice restriction devices may also prevent flow from traveling from pump 230-1 to pump 230-2 and or vice-versa. Such a restriction may prove beneficial in the event that either of the pumps, pump 230-1 or pump 230-2 become nonfunctional and unable to maintain pressure. In such a situation, in accordance with principles of inventive concepts, the other pump may continue to remain functional and may continue to provide a functioning pumping system 200.

A monitor, analysis and control system 10 in accordance with principles of inventive concepts may include a thermal sensing and/or thermal reactive device, which may cause the inertial mass unit to disengage other elements of the monitor, analysis and control system 10 and/or otherwise halt operation of the pumping system 200 should temperatures of the pumping system and/or the locale in the vicinity of the pumping system elevate to a predetermined temperature condition. The disengagement of the system may be for a period of time determined by the temperature of the pumping system and/or the environment in/or near the pumping system 200 or may be for a predetermined time, and/or may be until external actions are taken, for example, by an operator, to alleviate the temperature-related condition.

An example embodiment of such a device may include a thermal actuator assembly 400. The thermal actuator assembly may be fixedly attached to a pump cylinder head 208, and/or another element of the pump assembly 230-1, 2. The thermal actuator may have an actuation arm 401 that may operate from a cold, contracted, position 1 to a heated, extended, position 2. The thermal arm 401 may have a proximal end that extends into an actuator assembly body 402 and a distal end that is fixed to a pressure activation switch member 403 that controls an air valve 404 controlling air entry into pressure/deactivation switch 303 such that when the thermal actuator 401 is in position 1, the inactive state, the air may pass through valve 404 to switch 303, and switch 303 may pressurize to cause member 334 to extend and activate elevator activating arm 124.

When the thermal actuator arm 401 is in the active state, position 2, the arm may contact member 403, actioning valve 404. Rod 405 within valve 404 may move from an extended position to a contracted position. Movement of rod 405 to a contracted position may cause orifice 407 on shuttle 406 to be blocked by rod 405, blocking air passage from orifice 409 to activation switch 303. As rod 405 continues to travel to position 2, shuttle 406 may move with rod 405 exposing orifice 407 to the activation/deactivation switch 303. The orifice 407 may be at atmospheric pressure, which may result in the activation/deactivation switch 303 depressurizing and moving to a deactivation state, which may deactivate the pump assembly. Should the thermal actuator assembly 400, conversely, cool after a heated thermal event, the extended actuation arm 401 may move from an extended position 2 to a retracted position 1. The retraction of the thermal arm 401 may then result in the pressure activation switch member 403 that controls an air valve 404 to move rod 404 into an extended position and thus allow air passage through the valve 404 from the regulator valve 302 to the actuation switch 303.

In accordance with principles of inventive concepts, a control system may be configured with mechanical elements as has been described and may alternatively be configured with mechanical and electrical elements within the system as well. An electrical switching system in accordance with principles of inventive concepts may include the state position valve 381 and the associated linking pivot 307 and elevator activating arm 124 as described in the discussion related to the mechanical switching system 301. The switching system may have one or more switching devices 360. The switching devices may be coupled and/or pass/receive fluid and/or restrict fluid by use of reservoirs and/or fluid transfer devices which may include hoses, tubes, constructed members to create pathways, internally molded pathways within a member or element, and/or a combination of any and/or all these methods and/or constructs.

The state position valve 381, the switching devices 360 and/or other control devices may be actioned, or activated, with a pulse width modulated (PWM) set of inputs controlled by the controller (for example, MCU) and/or possibly direct current (DC) control, which may be supplied directly from the electrical power generator and/or multiple methods. The selection of PWM and/or generator DC may be determined based on a number of factors, including open time and/or power on duration, heat build-up, power budget, power conditioning capability, etc. For example, PWM may reduce power loads on the system and generate less heat and allow a more efficient system operation, while power supplied directly from the power generator will allow an added degree of simplicity with a lesser need for power conditioning. Decisions as to type of powering method may be determined depending on many factors including but not limited to those identified above.

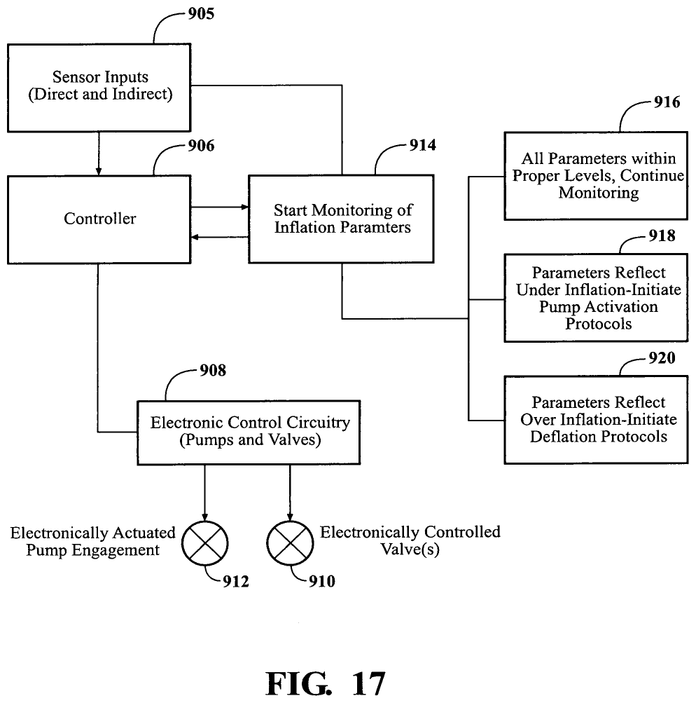

An exemplary embodiment of an electrical activated switching system may be constructed to allow the control of valves that, in turn, control the fluid and/or air paths within the system, as depicted schematically in FIGS. 17, 18 and 19. The valves in an electronic control embodiment in accordance with principles of inventive concepts may be controlled by a controller 906 that may activate electronic control circuitry 908 to open and close valves 910 and operate pump 912 in the system, depending on the inputs received from direct and indirect sensors 905, as well as being directly controlled by a mobile app, for example.

Illustrated in FIGS. 17, 18, and 19 an example embodiment of a system 10 including mechanical, electro-mechanical, and electronic elements in accordance with principles of inventive concepts may include a state position valve and an associated linking pivot and elevator activating arm as described in the discussion related to a mechanical switching system described in greater detail in co-filed applications incorporated by reference herein. The switching system may have one or more switching devices. The switching devices may be coupled and/or pass/receive fluid and/or restrict fluid by use of reservoirs and/or fluid transfer devices which may include hoses, tubes, constructed members to create pathways, internally molded pathways within a member or element, and/or a combination of any and/or all these methods and/or constructs.

The state position valve, the switching devices and/or other control devices may be actioned, or activated, with a pulse width modulated (PWM) set of inputs controlled by the controller 906 or, for example, direct current (DC) control, which may be supplied directly from the electrical power generator or other methods. The selection of PWM and/or generator DC may be determined based on a number of factors, including open time and/or power on duration, heat build-up, power budget, power conditioning capability, etc. For example, PWM may reduce power loads on the system and generate less heat and allow a more efficient system operation, while power supplied directly from the power generator will allow an added degree of simplicity with a lesser need for power conditioning.

An exemplary embodiment of an electrical activated switching system may be constructed to allow the control of valves, for example, valves 910 that, in turn, control the fluid and/or air paths within the system, as depicted schematically in FIG. 17. The valves in an electronic control embodiment in accordance with principles of inventive concepts may be controlled by a controller 906 that may activate electronic control circuitry 908 (which may include elements of previously described electrical system 216) to open and close various valves in the system, depending on the inputs received from direct and indirect sensors, as well as being directly controlled by a mobile app, for example. Electronic control circuitry 908 may also operate a pump actuation system 912 to engage or disengage a pump to compress fluid for tire inflation, for example.

The block diagram of FIG. 18 depicts an example embodiment of a system 10 including a controller that employs valve control circuits 1-6 to operate valves to: (controller 1) admit pressurized air from a pump to a first reservoir directly associated with a tire (tire A). A controller (controller 3) operates a corresponding valve to supply compressed air from reservoir 1 to tire A. Controller 2 operates a valve that operates to vent compressed air from reservoir 1 to atmosphere. Valve controller 6 operates a valve to operate a piston to start the pump. Valve controller 4 operates an equalization valve employed to equalize pressures between reservoirs 1 and 2. Valve controller 5 operates a valve to supply pressurized air from reservoir 2 to tire B.

In example embodiments, system 10 may monitor temperatures and pressures of the tire(s) and using logic within controller (a MCU, for example), may use multiple inputs to confirm the integrity of the sensor inputs and then decide whether to simply keep monitoring the system, to inflate the system, or, for example, to deflate a tire or other components of the system by engaging the pump and opening and closing valves in the airflow path. There may be planned inflation protocols, deflation protocols, pump activation protocols, and monitoring protocols, all to be contained within in the main controller, for example.

In example embodiments switching device may include a plurality of valves that may be actuated by electrical signals. These valves and/or switches may be configured to provide a closed and/or an open position and may be configured to provide control of fluid passage and/or may actuate mechanical elements within the system. There may be a configuration that provides control of fluid within one or a plurality of tires and/or reservoirs. An exemplary system may include one or more sensors. The sensor(s) may assess such parameters as pressure and temperature or other system characteristics, for example. The sensor(s) are positioned to provide access to parameters generated within or by a tire and/or reservoir of interest. Parameter data may be periodically and/or continuously monitored by a control module. Controller 906 receives selected input data from one or more sensors, performs a variety of calculations, comparisons, and/or analysis on the incoming data, which may result in activation of one or more valves and/or switching devices. The operation of these switching devices may be simultaneously and/or in a prescribed order. The duration of activation of these switching devices also may be varied based on a prescribed activation protocol.

In example embodiments in accordance with principles of inventive concepts, the switching system shown in FIG. 10 may operate according to the logic diagram FIG. 17. In example embodiments, controller 906 monitors inflation parameters 914, including a plurality of sensor inputs, such as tire pressure, temperature, accelerometer inputs, etc., as well as analysis results and longitudinal results (for example, sensor inputs and analysis results over time). The monitoring process ensures that all parameter values are within a proper range 916, and, if so, continues monitoring the parameter values. If parameter values indicate that a tire is under-inflated, pump activation protocols may be initiated 918 to engage a pump using, for example, electronic control circuitry 908 and electronically activated pump engagement elements 912 (for example, solenoids or electric motor). A tire may be “under-inflated” in a variety of senses. For example, for load-leveling, a tire may be considered under-inflated if it is at a lower pressure than other tires on a vehicle, either on the same wheel-end or on another wheel-end. Or, a tire may be under-inflated in the sense that it is below a preset threshold pressure.

Similarly, if parameter values indicate that a tire is over-inflated, pump activation protocols may be initiated 920 to engage a pump using, for example, electronic control circuitry 908 and electronically activated pump engagement elements 912 (for example, solenoids or electric motor). A tire may be “over-inflated” in a variety of senses. For example, for load-leveling, a tire may be considered over-inflated if it is at a higher pressure than other tires on a vehicle, either on the same wheel-end or on another wheel-end. Or, a tire may be over-inflated in the sense that it is above a preset threshold pressure.

In such example embodiments, should a sensor detect a pressure reading below targeted level, a first sensor or second sensor may read a low pressure, which may be transmitted to controller 906. Controller 906 may signal, or command, an opening of a switch/valve having fluid transmission passage leading to a tire or other reservoir, or a second switch/valve having fluid transmission passage leading to a second tire or other reservoir, and a simultaneous or subsequent opening of a third switch/valve which may be for a prescribed duration. The opening of third switch/valve, subsequent and/or coincident to the opening of first switch/valve or second switch/valve, may cause pressurized fluid to enter state position unit, resulting in activation of torque transmission system and operation of pumping system.

Pumping of fluid by the pumping system may flow into discharge reservoir. The controller 906 may periodically activate switch/valve, based on analysis of various system related parameters. The opening of either or both valves may result in charging the first or second tire or a reservoir. The system may continue to operate in this manner, until the controller 906 determines, based on data sampling and/or analyses, a change action should occur. One such action may be the termination of pumping. Such an action may result from Controller 906 signaling a close status for first or second switch/valve, a subsequent opening of discharge switch/valve leading to atmosphere, or coincidently an opening of third switch/valve. The opening of both switches/valves may result in a lowering of pressure in the/a cavity leading to state position valve which, as described previously, may result in the disengagement of torque/force transmission device and subsequent termination of pumping by pumping system.

With two tires connected to a system 10 and the valving of the system may be operated with intent to equalize pressures within and between a dual set of tires. In such an example embodiment, readings from sensors associated with each tire are in a state of difference. Equalization would entail the following: opening a first valve for a prescribe period and then shutting it. Tire pressure in a first tire may inflate discharge reservoir to pressures as experienced in first tire. First valve is then opened for a prescribed period of time and then shut again filling discharge reservoir this time with pressure from second tire. The process may continue, alternating the opening and shutting process between the first and second valves until first and second sensors achieve a like reading. Alternatively, both first and second valves could be maintained in an open state at the same time for a prescribed period of time and then both shut. This could allow flow of air between the tires and thus equalizing of tire pressure.

In order to reduce pressure in an over-inflated tire, system 10 operate as follows. Tire over-inflation may be as a result of a variety of factors, such as heating of the ambient environment as the vehicle travels from one climate to another, and/or operational heating, for example. The adjustment of such a condition may include the relieving of pressure from the overinflated tire by opening first or second valve, as determined to be the tire exhibiting an over pressure condition for a predetermined period of time. The air from the tire flows into discharge reservoir then the discharge valve is opened for a prescribed period, thereby discharging reservoir to atmosphere. This process may be repeated until the sensor that indicated excess pressure provides a target pressure reading.

In example embodiments, system 10 may monitor temperatures and pressures of the tire(s) and using logic within controller (an MCU, for example), may use multiple inputs to confirm the integrity of the sensor inputs and then decide whether to simply keep monitoring the system, to inflate the system, or, for example, to deflate a tire or other components of the system by engaging the pump and opening and closing valves in the airflow path. There may be planned inflation protocols, deflation protocols, pump activation protocols, and monitoring protocols, all to be contained within in the main controller, for example.

In example embodiments switching device may include a plurality of valves 360 that may be actuated by electrical signals. These valves and/or switches may be configured to provide a closed and/or an open position and may be configured to provide control of fluid passage and/or may actuate mechanical elements within the system. There may be a configuration that provides control of fluid within one or a plurality of tires and/or reservoirs. An exemplary system may include one or more sensors 355. The sensor(s) may assess such parameters as pressure and temperature or other system characteristics, for example. The sensor(s) are positioned to provide access to parameters generated within or by a tire and/or reservoir of interest. Parameter data may be periodically and/or continuously monitored by a control module. The control module 358 receives selected input data from one or more sensors 355, performs a variety of calculations, comparisons, and/or analysis on the incoming data, which may result in activation of one or more valves and/or switching devices 360. The operation of these switching devices 360 may be simultaneously and/or in a prescribed order. The duration of activation of these switching devices also may be varied based on a prescribed activation protocol.

In example embodiments in accordance with principles of inventive concepts, the switching system shown in FIG. 18 may operate according to the logic diagram FIG. 17. In such example embodiments, should a sensor detect a pressure reading below targeted level, the sensor 355a and/or sensor 355b may read a low pressure, which may be transmitted to control unit 358. Control unit 358 may signal, or command, an opening of switch/valve 351 having fluid transmission passage leading to tire 19a or other reservoir, and/or switch/valve 352 having fluid transmission passage leading to tire 19b or other reservoir, and a simultaneous and/or subsequent opening of switch/valve 353, which may be for a prescribed duration. The opening of switch/valve 353, subsequent and/or coincident to the opening of switch/valve 351 and/or 352, may cause pressurized fluid to enter state position unit 351, resulting in activation of torque transmission system 100 and operation of pumping system 200. Pumping of fluid by the pumping system 200 may flow into discharge reservoir 357. The control unit 358 may periodically activate switch/valve 351 and/or 352 based on analysis of various system related parameters. The opening of either or both valves may result in charging the tire 19a and/or tire 19b and/or a reservoir. The system may continue to operate in this manner, until the control unit 358 determines, based on data sampling and/or analyses, a change action should occur. One such action may be the termination of pumping. Such an action may result from Control unit 358 signaling a close status for switch/valve 351 and 352, a subsequent opening of discharge switch/valve 354 leading to atmosphere, and/or coincidently an opening of switch/valve 353. The opening of both switches/valves 354 and/or 353 may result in a lowering of pressure in the/a cavity leading to state position valve 381 which, as described previously, may result in the disengagement of torque/force transmission device 100 and subsequent termination of pumping by pumping system 200.

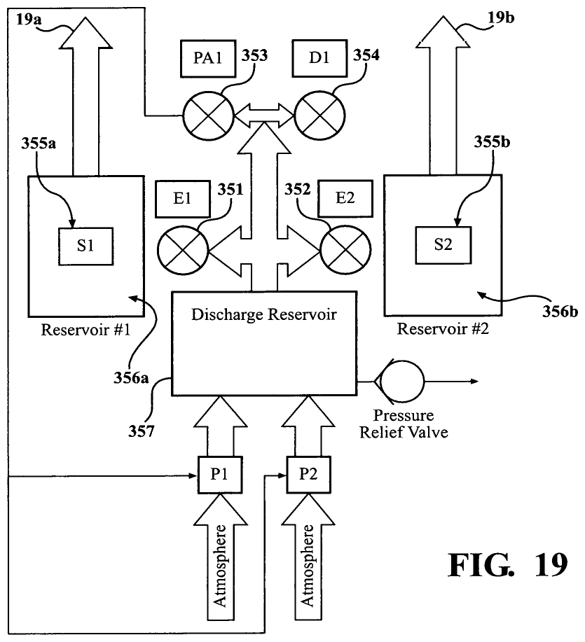

An alternative exemplary performance may occur as shown in logic diagram FIG. 19 and described as follows for a system whereby there are two tires 19 connected to a monitor, analysis and control system 10 and the valving of the system is operated with intent to equalize pressures within and between a dual set of tires 19 operating on a single monitor, analysis and control system 10. In such an example embodiment, readings from sensor 355a and 355b are in a state of difference. Equalization would entail the following: opening valve 351 for a prescribe period and then shutting it. Tire pressure in tire 19a may inflate discharge reservoir 357 to pressures as experienced in tire 19a. Valve 352 is then opened for a prescribed period of time and then shut again filling discharge reservoir 357 this time with pressure from tire 19b. The process may continue, alternating the opening and shutting process between the valves 351 and 352 until sensors 355a and 355b achieve a like reading. Alternatively, both valves 351 and 352 could be maintained in an open state at the same time for a prescribed period of time and then both shut. This could allow flow of air between the tires and thus equalizing of tire pressure.

An alternative exemplary operation in accordance with principles of inventive concepts may be implemented as shown in logic diagram FIG. 17 and described as follows for a system whereby there are one or more tires 19 connected to a monitor, analysis and control system 10 10 and the valving of the system is operated with intent to reduce pressure in an overinflated tire. Tire over-inflation may be as a result of a variety of factors, such as heating of the ambient environment as the vehicle travels from one climate to another, and/or operational heating, for example. The adjustment of such a condition may include the relieving of pressure from the overinflated tire by opening valve 351 and/or 352, as determined to be the tire exhibiting an over pressure condition for a predetermined period of time. The air from the tire flows into discharge reservoir 357 then the discharge valve 354 is opened for a prescribed period, thereby discharging reservoir 357 to atmosphere. This process may be repeated until sensor 355a and/or 355b which may have been indicating an over pressure, indicated the desired pressure value.

In accordance with principles of inventive concepts, monitor, analysis and control system 10 may be controlled using electrical/electronic control systems. Such systems may rely on both direct and/or indirect sensor inputs. In example embodiments, this control system is capable of communicating both the actions performed and/or the predictive information to a vehicle driver and/or the vehicle maintenance/logistics manager, for example.

In example embodiments a system may include an MCU to actively and continuously monitor (i.e.: many times, per second) all sensors when the vehicle and/or the monitor, analysis and control system is in motion, and, upon request, when the vehicle and/or monitor, analysis and control system is not in motion though at lower frequency rates. Power for the system may be from a power generator assembly 105, which may provide continual power to the monitor, analysis and control system 10 whenever the vehicle is in motion. This continual availability of power may allow sustained sampling protocols for sensors and other inputs at a rate much greater than is possible with fixed energy (e.g. non-rechargeable battery) source devices, such as conventional monitor, analysis, and control system devices. These higher sampling rates not only provide a greater level of real-time knowledge of what is transpiring within the system, but may also allow for much greater capabilities as to signal analysis.

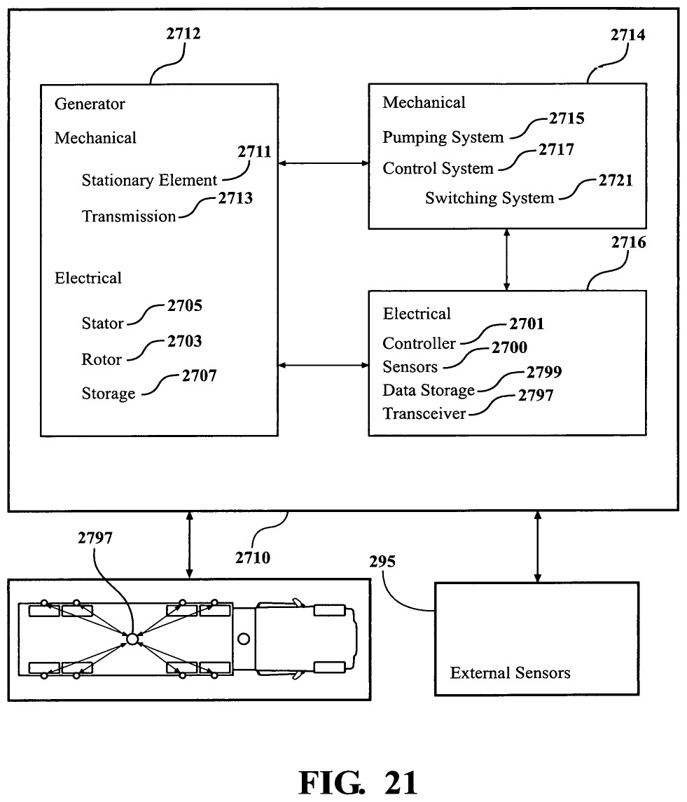

The conceptual block diagram of FIG. 21 provides an overview of an example embodiment of a vehicle monitoring and adjustment system 2710 in accordance with principles of inventive concepts. System 2710 includes a power generator 2712, a mechanical system 2714 and an optional electrical system 2716, all of which may be mounted to a vehicle's wheel-end.

Power generator 2712 includes quasi-stationary element 2711 (a weighted pendulum in example embodiments), which is supported along a central axis of the system on a system support shaft and is free to rotate thereabout. Although free to move about the axis of a shaft, quasi-stationary element 2711 remains substantially stationary in its own reference frame, while rotating about the shaft in the reference frame of a substantial portion of the system 2710. Quasi-stationary element 2711 may also be referred to herein as stationary element or pendulum, for example. Transmission 2713 couples pendulum 2711 to mechanical pumping system 2715 and mechanical switching system 2721, which, along with transmission 2713, rotates along with the rotation of the vehicle's wheel. With the transmission 2713 and pumping system 2715 rotating and pendulum 2711 substantially stationary, the pendulum 2711 applies a torque to the transmission 2713, which transfers the torque to pumping system 2715. The mass size and configuration, and the lever arm length of pendulum 2711 are chosen to deliver sufficient torque for pump, and electrical generation actions through a wide range of a vehicle's operating speeds, without excessive travel of the pendulum. In example embodiments power generator 2712 may also include an electrical generator 2709 and electrical storage 2707 (also referred to herein, simply, as a “battery”), used to power electrical system 2716. In example embodiments, electrical generator 2709 is coaxial with a system support shaft, with the generator's stator 2705 coupled to the system support (thereby rotating with the rotational portion of the system) and the generator's rotor 2703 is coupled to the pendulum 2711, thereby remaining substantially stationary; the relative rotation between the stator 2705 and rotor 2703 generates electricity.

Mechanical system 2714 includes mechanical control 2717 (including mechanical switching 2721), pumping 2715, and filtration 2719, each of which will be described in greater detail below. Mechanical control system 2717 engages transmission 2713 with pendulum 2711 within a range of operational parameter values and disengages transmission 2713 from pendulum 2711 outside that range. Pumping system 2715 translates rotational movement provided by transmission 2713 into linear movement used to operate pistons that compress air for use in maintaining proper tire pressure.

Electrical system 2716 may include a controller 2701, which may be embodied as microcontroller, or microprocessor and various support electronics, for example. Controller 2701 may obtain data from a variety of sensors 2700 and operate upon the data for a variety of analytical, control, storage, and transmission functions, as will be described in greater detail below. These sensors may include sensors internal to the monitor, analysis and control system unit as well as those that may be external to the unit, sensors 2795.

The availability of an electrical power generating source within this inventive system afford the opportunity to perform many functions not available with a fixed electrical source which needs to conserve energy. Examples include the ability to sample sensors at much higher rates and for much longer durations than would typically be done in a battery powered system. Additionally, the presence of a powerful processor, such as a microcontroller (MCU), or possibly a System-On-Chip (SOC) within the unit, allows the ability to perform intensive signal processing functions. As example, sampling of accelerometer data at 16 KHZ can be performed continuously while performing Fast Fourier Transforms (FFT's) or Discrete Fourier Transforms (DFT's) via a 32-Bit MCU on the resulting signals, allowing the gathering of not only accelerometer magnitudes, which indicate things such as pot hole events, but also frequency information which are only available via much more power demanding operations that the aforementioned on-board processor can perform. This data can be very powerful as detailed following. As example, when sampling raw 10-bit or 12-bit data over long intervals (typically at least one second recordings) at very fast rates (typically at a minimum of 16 KHZ) a sample file of the accelerometer recording of events that contain an array of precisely timed sensor readings can be obtained. The result is that rather than just time domain data, frequency domain data can also be extracted. This allows significantly greater degree of signal processing capabilities, up to and including machine learning algorithms. The system having a continuous internal power generating source capability allows the sampling of an increased number of sensors, fast and continuously. The use of a main processor housed within the unit, allows sampling and analysis at the highest speeds and to the fullest capabilities. This allows the continuous monitoring and analysis of a variety of functions, components, and performances that would fall under the general heading of “wheel end health”. These would include such things as monitoring wheel imbalance detectable only via frequency domain readings of the accelerometer sensors; comparing the frequency domain results of one wheel, say wheel “A”, to the frequency results of a second wheel, say wheel “B”. The comparison will allow better discrimination between environmental effects, such as a bumpy road condition, that all tires may be experiencing, vs. single events that only one wheel may experience, such as damaging a tire from hitting a curb or pot hole. The processing capabilities of an always powered system, recording at very high data rates, over long periods of time, and the ability of the wheel ends to communicate with each other and share their data, allow the creation of a very powerful wheel end health monitoring system with diagnostic and prognostic capabilities at each wheel end, assessing performance for wheel ends, extending to axle assemblies and units in total (e.g. axle alignment, etc.).

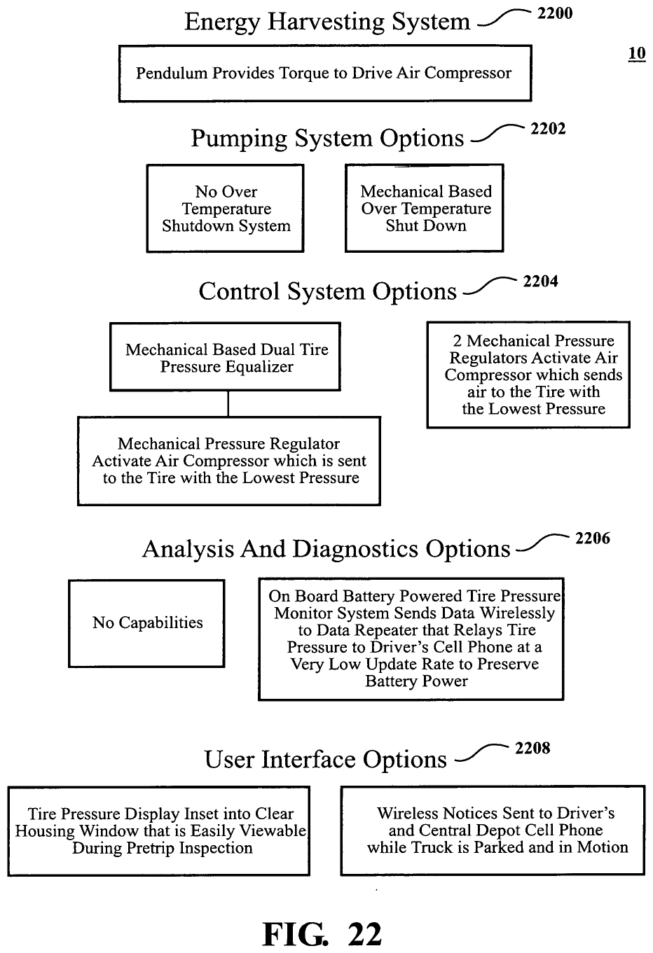

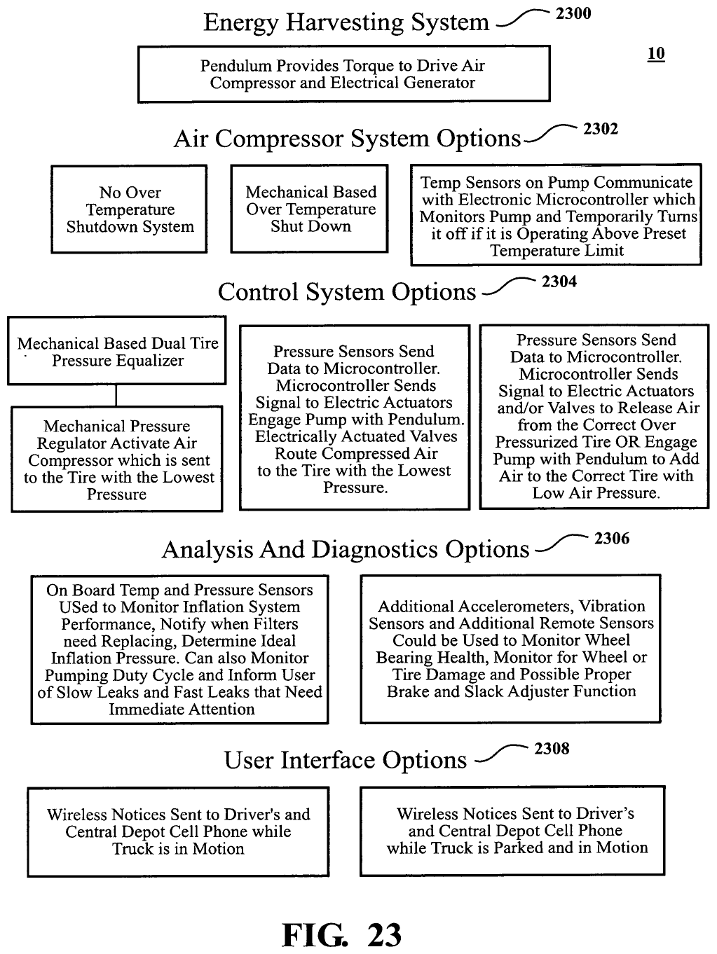

In example embodiments a wheeled vehicle monitoring, analysis and control system in accordance with principles of inventive concepts, and a wheel-end unit of such a system, in particular, may be a modular system so that, for example a wheel-end unit may include mechanical power generation whereby a pendulum (also referred to herein as a quasi-stationary element) provides torque to drive a compressor, an activation and engagement mechanism, a transmission system, valves, and mechanical control elements, as depicted in the block diagram of FIG. 22. In other example embodiments a wheel-end unit may add electrical generation, activation and control, using the same packaging, layout, and interfaces, as illustrated in the block diagram of FIG. 23.

In mechanical embodiments depicted by the block diagram of FIG. 22, a wheel-end system includes energy harvesting system 2200, pumping system 2202, control system 2204, analysis and diagnostic system 2206, and user interface 2208. Energy harvesting system includes a pendulum that provides torque to drive an air compressor; a purely mechanical system as previously described. Pumping system 2202 may provide (or not) an over-temperature shutdown that is purely mechanical. Mechanical control system 2204 options include: dual tire pressure equalizer; an active air compressor that is regulated to supply compressed air to whichever of a pair of tires is at a lower pressure; and two mechanical pressure regulators that send compressed air to whichever of a pair of tires is at a lower pressure. In a mechanical embodiments there may be diagnostic 2206 implementations with no analytical and diagnostic capabilities or there may be battery-powered analytical and diagnostic capabilities that include tire pressure sensors and communications interfaces to relay tire pressure or other sensor data. User interfaces 2208 may include, for example, a tire pressure display included in a wheel-end unit housing or wireless communication of tire pressure or other sensor data sent, for example, to a mobile electronic device, such as a cell phone, for example.

In combined electrical/mechanical embodiments, such as depicted in the block diagram of FIG. 23, a wheel-end system includes energy harvesting system 2300, pumping system 2302, control system 2304, analysis and diagnostic system 2306, and user interface 2308. Energy harvesting system 2300 includes a pendulum that provides torque to drive an air compressor and electrical generator that provides electrical power for use in monitoring, analysis and control, as previously described. Pumping system 2302 may provide: no over-temperature shut-down; an over-temperature shutdown that is purely mechanical; or temperature sensors on a pump used in conjunction with an electronic controller that turns the pump on or off according to control parameters, for example, turning the pump off if the pump is operating at a temperature above a preset limit. Control system 2304 options include: mechanical dual tire pressure equalizer; mechanical active air compressor that is regulated to supply compressed air to whichever of a pair of tires is at a lower pressure; an electronic controller that employs electrical actuators to engage a pump with a torque-inducing pendulum to thereby initiate air compression and electrically activate valves to route compressed air to a tire at a lower pressure; and a an electronic controller that employs electrical actuators to engage a pump with a torque-inducing pendulum to thereby initiate air compression and electrically activate valves to route compressed air to a tire at a lower pressure or release air from an over-pressurized tire. In a mechanical/electrical embodiments there may be diagnostic 2306 implementations with a controller that monitors sensors, including temperature and pressure sensors, to monitor system performance, analyze system performance, provide maintenance alerts (for example, indicate when a filter requires replacement, or indicate when there is a leak in the system); and determine an optimum tire pressure for operating conditions (for example, for a given load or road condition). Other analysis and diagnostic 2306 implementations may employ additional accelerometers, vibration sensors, audio input, or other sensors to monitor wheel bearing “health,” or functionality, detect wheel or tire damage, and determine proper brake or slack adjuster function. User interfaces 2308 may include, for example, wireless communication of tire pressure or other sensor data sent, for example, to a mobile electronic device, such as a cell phone, for example, to notify a driver or maintenance operations center, dispatch center, etc. either while the vehicle is operating or while the vehicle is motionless.

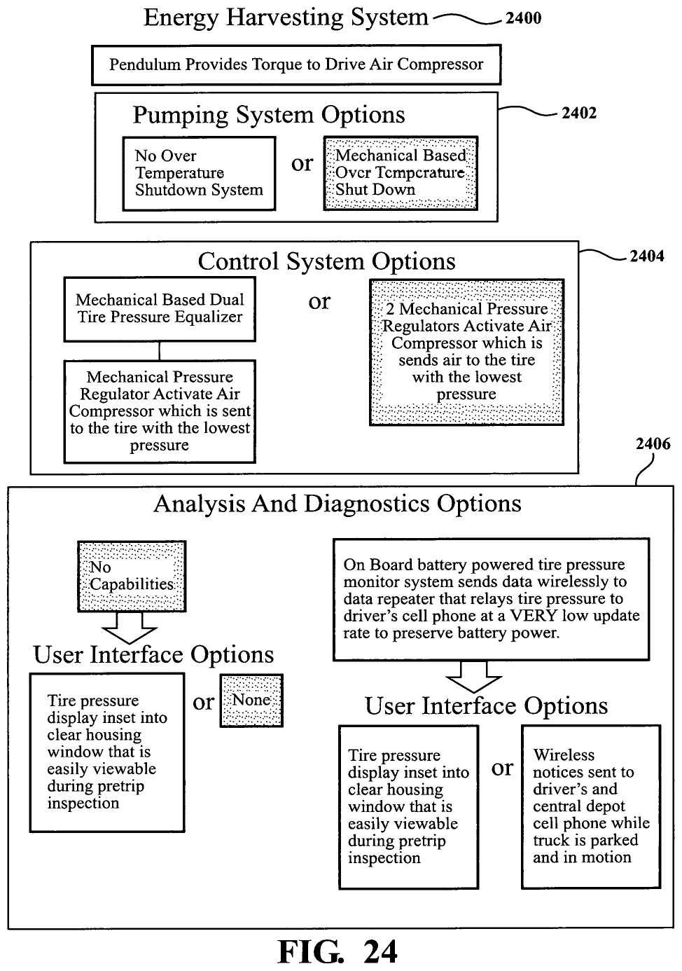

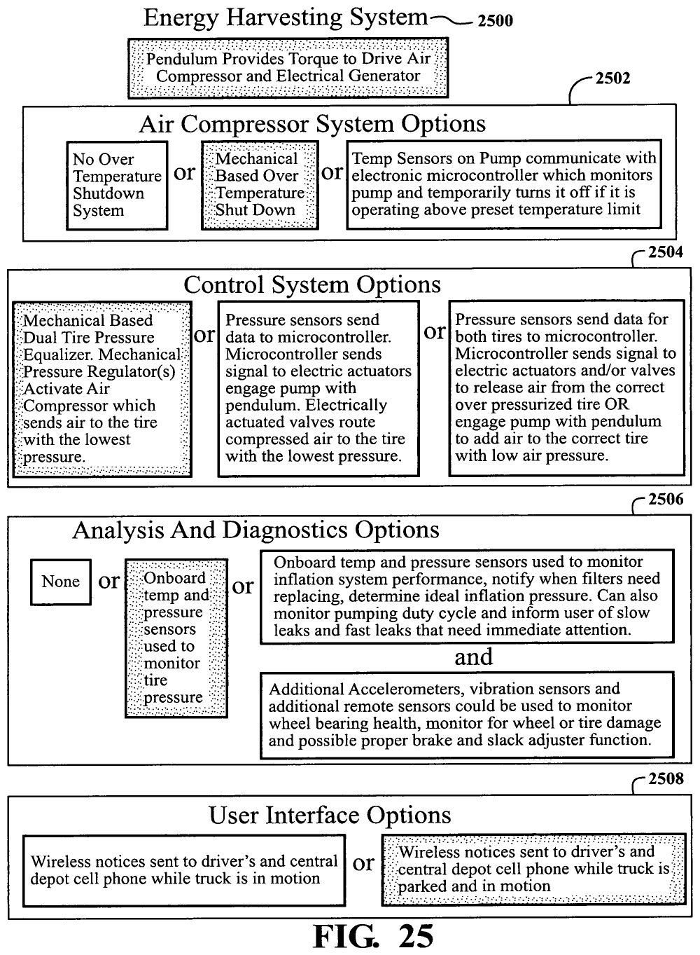

FIGS. 24 and 25 further illustrate the modularity of a wheel-end system 10 in accordance with principles of inventive concepts. The block diagram of FIG. 24 illustrates the modular options available with a mechanical implementation (that is, without an electrical generator) and that of FIG. 25 illustrates the modular options available with an electrical implementation (that is, an implementation that includes electrical generation and mechanical generation). As previously described in greater detail the electrical and mechanical implementations may employ the same housing, the same pendulum, virtually all the same components, with the exception that an electrical implementation adds an electrical generator and electronic components to the mechanical implementation.

The mechanical implementation depicted in FIG. 24 employs a mechanical energy harvesting system 2400 to generate mechanical power by employing a pendulum to generate a torque that drives an air compressor, as previously described. Pumping system options 2402 include the option of including a mechanical-based over-temperature shutdown (as depicted by the shading within pumping system options block 2402. Control system options 2404 include employing two mechanical pressure regulators to activate an air compressor that sends air to whichever tire of a pair of tires has a lower tire pressure, the selected option being indicated by the shading within block 2404. In the example embodiment of FIG. 24 shading within the analysis and diagnostic options block 2406 indicates that no diagnostic or user interface options have been selected for the illustrated implementation. Due to the wheel-end system's modularity, other implementations, employing the same physical layout, may add a tire pressure display or a battery-powered tire pressure monitoring system, for example.

The electrical implementation depicted in FIG. 25 employs both mechanical and electrical energy harvesting systems 2500 powered, as previously described, by the relative motion between a pendulum, or quasi-static element, and a rotating vehicle wheel. Due to wheel-end system's 10 modular design, electrical implementations may employ the same physical layout (for example, pendulum placement, housing, mechanical power generation, etc.) as mechanical implementations and require only the addition of an electrical generator and electronics which, again, do not interfere with existing mechanical power components. Shading within the air compressor system option box 2502 indicates that this illustrative embodiment employs a mechanical based over-temperature shut down, although an electrical shut down option is available. Of the control system options 2504 shading indicates that a mechanical based dual tire pressure equalizer is employed, although options are available that employ electronics including pressure sensors and electronic controllers (e.g., microcontroller) to implement pressure equalization. The shading within analysis and diagnostic options box 2506 indicates that onboard temperature and pressure sensors are used to monitor tire pressure and temperatures. Other options afforded by an electrical implementation include pump duty cycle, and additional sensors, including accelerometers and corresponding analyses as previously described. User interfaces 2508 include wireless notices that may be sent regardless of whether the truck is in motion or not.

While the present inventive concepts have been particularly shown and described above with reference to example embodiments thereof, it will be understood by those of ordinary skill in the art, that various changes in form and detail can be made without departing from the spirit and scope of inventive concepts as defined by the following claims.

What is claimed is:

1. A wheel-end unit for monitoring a vehicle wheel-end, comprising:
a sensor to sense a physical characteristic of a vehicle to which the monitoring unit is attached; and
wheel-end energy harvester, comprising:
a non-rotating element;
a rotatable element coupled to a wheel;
a transmission system including non-circular and non-centered gears;
an engagement element to couple the non-rotating element to the rotatable element, wherein the non-rotating element generates a torque when engaged with the rotatable element and the rotatable element is rotating and the transmission system transmits the torque in the form of usable energy; and
a modular control system for controlling a parameter of the wheel-end unit, the modular control system including mechanical control.

2. The system of claim 1 wherein the usable energy includes mechanical energy.

3. The system of claim 2, wherein the mechanical energy is employed to operate a fluid pumping system.

4. The system of claim 2 wherein usable energy includes electrical energy.

5. The system of claim 4, wherein the modular control system includes mechanical control elements.

6. The system of claim 5, wherein the modular control system include electrical control elements.

7. The system of claim 6, wherein the electrical control elements include a controller to collect readings from a sensor and to employ sensor readings to analyze operation of the vehicle.

8. The system of claim 7, wherein the analysis of sensor readings includes trend analysis.

9. A system for monitoring a vehicle, comprising:
a plurality of wheel-end units for attachment to a wheeled vehicle wheel-end, each including:
a sensor to sense a physical characteristic of a vehicle to which the monitoring unit is attached; and
wheel-end energy harvester, comprising:
a non-rotating element;
a rotatable element coupled to a wheel;
a transmission system;
an engagement element to couple the non-rotating element to the rotatable element, wherein the non-rotating element generates a torque when engaged with the rotatable element and the rotatable element is rotating and the transmission system transmits the torque in the form of usable energy; and
a modular control system for controlling a parameter of the wheel-end unit, the modular control system including mechanical control.

10. The system of claim 9 wherein the usable energy includes mechanical energy.

11. The system of claim 10, wherein the mechanical energy is employed to operate a fluid pumping system.

12. The system of claim 10 wherein usable energy includes electrical energy.

13. The system of claim 12, wherein the modular control system includes mechanical control elements.

14. The system of claim 5, wherein the modular control system include electrical control elements.

15. The system of claim 14, wherein the electrical control elements include a controller to collect readings from a sensor and to employ sensor readings to analyze operation of the vehicle.

16. The system of claim 15, wherein the analysis of sensor readings includes trend analysis.

17. A method in a wheel-end monitoring unit for monitoring a vehicle wheel-end, comprising:
a sensor to sensing a physical characteristic of a vehicle to which the monitoring unit is attached; and
wheel-end energy harvester employing:
a non-rotating element;
a rotatable element coupled to a wheel;
a transmission system;
and an engagement element to couple the non-rotating element to the rotatable element, wherein the non-rotating element generates a torque when engaged with the rotatable element and the rotatable element is rotating and the transmission system transmits the torque in the form of usable energy; and
a modular control system controlling a parameter of the wheel-end unit, the modular control system including mechanical control.

18. The method of claim 17 wherein the usable energy includes mechanical energy.

19. The system of claim 18, wherein the mechanical energy is employed to operate a fluid pumping system.

20. The method of claim 18 wherein usable energy includes electrical energy, the modular control system includes mechanical control elements and electrical control elements to control characteristics of the vehicle wheel-end, including the tire pressure of a tire coupled to the wheel-end.
